(19) United States
(12) Patent Application Publication
(10) Pub. No.: US 2024/0367882 A1
(43) Pub. Date: Nov. 7, 2024

(54) A BEVERAGE CONTAINER, AND A METHOD OF ASSEMBLING A BEVERAGE CONTAINER

(71) Applicants: Asahi Group Holdings, Ltd., Tokyo (JP); Asahi Breweries, Ltd., Tokyo (JP)

(72) Inventors: Tomohisa MIYATANI, Ibaraki (JP); Masanori YAMAGISHI, Tokyo (JP); Motohiro INAGAKI, Tokyo (JP)

(21) Appl. No.: 18/690,004

(22) PCT Filed: Jul. 12, 2022
(86) PCT No.: PCT/JP2022/027408

§ 371 Date: Mar. 7, 2024

(30) Foreign Application Priority Data
Nov. 25, 2021 (JP) 2021-191543

(51) Int. Cl. B65D 77/06; B65D 83/38; B65D 83/62

(52) U.S. Cl. CPC B65D 77/06; B65D 83/38; B65D 83/62

(57) ABSTRACT

A beverage container includes an outer container having a first mouth portion, a lid member attached to the outer container, and a replaceable component attached to the lid member. The lid member includes an attachment portion attached to the first mouth portion, an upper pipe portion arranged outside the outer container, an annular portion extending outward from the upper pipe portion and connecting the upper pipe portion and the attachment portion, and a lower pipe portion extending downward from the annular portion. The replaceable component includes a sealing member slidable with respect to the lower pipe portion and being in annular contact with an outer surface of the lower pipe portion at an installation position, a tubular body holding the sealing member and being supported by the lower pipe portion via the sealing member located at the installation position, and a bag for containing a beverage attached to the tubular body.

### TECHNICAL FIELD

The present invention relates to a beverage container and a method of assembling a beverage container.

### BACKGROUND ART

A beverage container having a rigid outer container and a flexible inner container is known.

As a related art, Patent Literature 1 discloses a container containing a storage bag. The container described in Patent Literature 1 includes an outer container (5) having an opening (22), a storage bag (1) accommodated in the outer container (5) and having a spout (4), and a lid portion (8) connected to both the storage bag and the outer container. In Patent Literature 1, it is described that a hole portion of the spout (4) and a hole portion of the lid portion (8) are fitted, and that the spout (4) and a pouring nozzle (6) are connected.

Patent Literature 2 discloses a flexible container produced from a film material. The flexible container described in Patent Literature 2 includes a cap (5) attached to a neck of a rigid outer container (2), a fixing lip (4) forming a part of the cap (5), a bag (3) that is fixed to the fixing lip (4), a shut-off valve (10) that can be pushed in a downward direction, and a dispenser tube (8).

Patent Literature 3 discloses a beverage supply device. The beverage supply device described in Patent Literature 3 includes a container body (20) including a neck part (22), a flexible bag body (90) arranged inside the container body (20), a cap (30), and a cylinder body (50).

### CITATION LIST

### Patent Literature

[Patent Literature 1] WO 2015/156085 A1
[Patent Literature 2] WO 2001/000502 A1
[Patent Literature 3] JP 2018-30639 A

### SUMMARY

An object of the present invention is to provide a technique for facilitating the assembly of a beverage container including an outer container, a lid member, and a replaceable component having a bag.

A beverage container according to some embodiments includes an outer container having a first mouth portion, a lid member attached to the outer container, and a replaceable component attached to the lid member. The lid member includes an attachment portion attached to the first mouth portion, an upper pipe portion arranged outside the outer container, an annular portion extending outward from the upper pipe portion and connecting the upper pipe portion and the attachment portion, and a lower pipe portion extending downward from the annular portion. The replaceable component includes a sealing member slidable with respect to the lower pipe portion and being in annular contact with an outer surface of the lower pipe portion at an installation position, a tubular body holding the sealing member and being supported by the lower pipe portion via the sealing member located at the installation position, and a bag for containing a beverage attached to the tubular body.

A method of assembling a beverage container according to some embodiments includes: preparing an outer container having a first mouth portion; preparing a lid member that includes an attachment portion attachable to the first mouth portion, an upper pipe portion arranged outside the outer container, an annular portion extending outward from the upper pipe portion and connecting the upper pipe portion and the attachment portion, and a lower pipe portion extending downward from the annular portion; preparing a replaceable component that includes a sealing member, a tubular body holding the sealing member, and a bag for containing a beverage attached to the tubular body; attaching the replaceable component to the lower pipe portion; inserting the replaceable component and the lower pipe portion into the outer container; and attaching the attachment portion of the lid member to the first mouth portion of the outer container. Attaching the replaceable component to the lower pipe portion includes: sliding the sealing member and the tubular body with respect to the lower pipe portion; and making the sealing member into annular contact with an outer surface of the lower pipe portion at an installation position. Inserting the replaceable component and the lower pipe portion into the outer container includes: inserting the lower pipe portion, the sealing member attached to the lower pipe portion, the tubular body supported by the lower pipe portion via the sealing member, and the bag attached to the tubular body into the outer container through the first mouth portion.

According to the present invention, it is possible to provide a technique for facilitating the assembly of a beverage container including an outer container, a lid member, and a replaceable component having a bag.

### BRIEF DESCRIPTION OF THE DRAWINGS

FIG. 1 is a schematic cross-sectional view schematically showing a beverage container according to a first embodiment.

FIG. 2 is a schematic cross-sectional view schematically showing a state in which a beverage dispenser is connected to the beverage container according to the first embodiment.

FIG. 3 is a schematic cross-sectional view schematically showing how a replaceable component is attached to a lower pipe portion.

FIG. 4 is a schematic cross-sectional view schematically showing a state after the replaceable component is attached to the lower pipe portion.

FIG. 5 is a schematic cross-sectional view schematically showing an example of an outer container.

FIG. 6 is a schematic cross-sectional view schematically showing the beverage container according to the first embodiment.

FIG. 7 is a schematic cross-sectional view schematically showing a part of the beverage container according to the first embodiment.

FIG. 8 is a cross-sectional view taken along the line A-A of FIG. 7.

FIG. 9 is a schematic two-view schematically showing an example of a lid member.

FIG. 10 is a schematic cross-sectional view schematically showing a part of the beverage container according to the first embodiment.

FIG. 11 is a diagram for explaining each element of the replaceable component.

FIG. 12 is a schematic two-view schematically showing an example of the replaceable component.

FIG. 13 is a schematic cross-sectional view schematically showing a part of the beverage container according to the first embodiment.

FIG. 14 is a diagram for explaining an example of a removal-preventing member.

FIG. 15 is a diagram for explaining the removal-preventing member according to a first modified example.

FIG. 16 is a schematic cross-sectional view schematically showing a state in which a first closure member is attached to the lid member.

FIG. 17 is a schematic cross-sectional view schematically showing a state in which the first closure member according to a first modified example is attached to the lid member.

FIG. 18 is a schematic cross-sectional view schematically showing a state after a closing part of the first closure member according to the first modified example moves to an open position.

FIG. 19 is a schematic cross-sectional view schematically showing how the first closure member according to a second modified example is attached to the lid member.

FIG. 20 is a schematic cross-sectional view schematically showing a state after the closing part of the first closure member according to the second modified example moves to the open position.

FIG. 21 is a diagram for explaining an example of a gas valve.

FIG. 22 is a diagram for explaining another example of the gas valve.

FIG. 23 is a schematic cross-sectional view schematically showing a state during execution of an inserting step.

FIG. 24 is a schematic cross-sectional view schematically showing a state during execution of a beverage filling step.

FIG. 25 is a flow chart showing an example of a method of assembling a beverage container according to a second embodiment.

FIG. 26 is a flow chart showing an example of a method of handling a beverage container according to the second embodiment.

### DESCRIPTION OF EMBODIMENTS

Hereinafter, a beverage container 1 and a method of assembling the beverage container 1 according to some embodiments will be described with reference to the drawings. In the following description, members and portions having the same function are donated by the same reference numerals, and the repeated descriptions of members and portions denoted by the same reference numerals are omitted.

### Definition of Direction

In this specification, a direction from a lower pipe portion 37 of a lid member 3 to an upper pipe portion 34 of the lid member 3 is defined as “upward”, and a direction from the upper pipe portion 34 of the lid member 3 to the lower pipe portion 37 of the lid member 3 is defined as “downward”.

In this specification, a term “outward” means a direction away from a central axis C1 of the upper pipe portion 34 of the lid member 3. Further, a term “inward” means a direction toward the central axis C1 of the upper pipe portion 34 of the lid member 3.

### First Embodiment

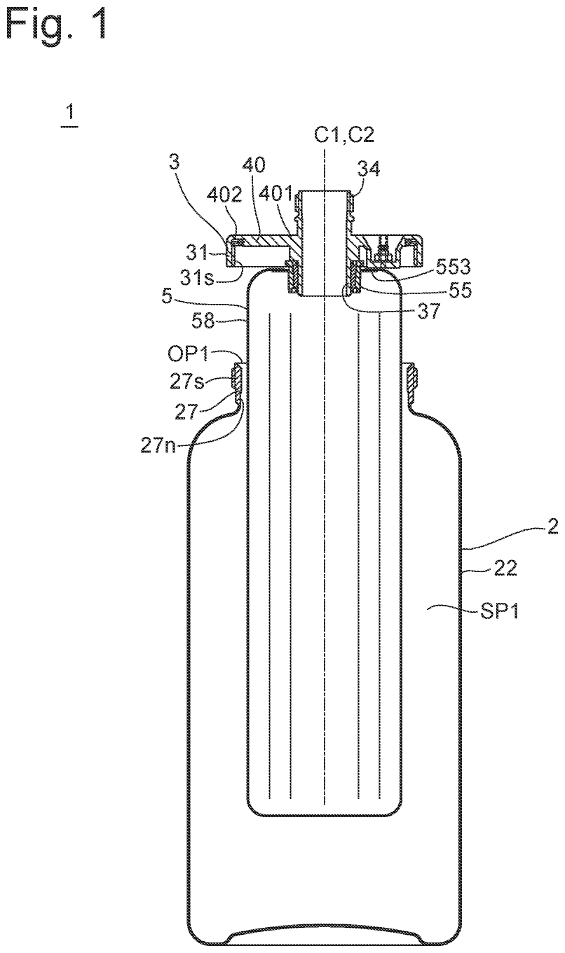

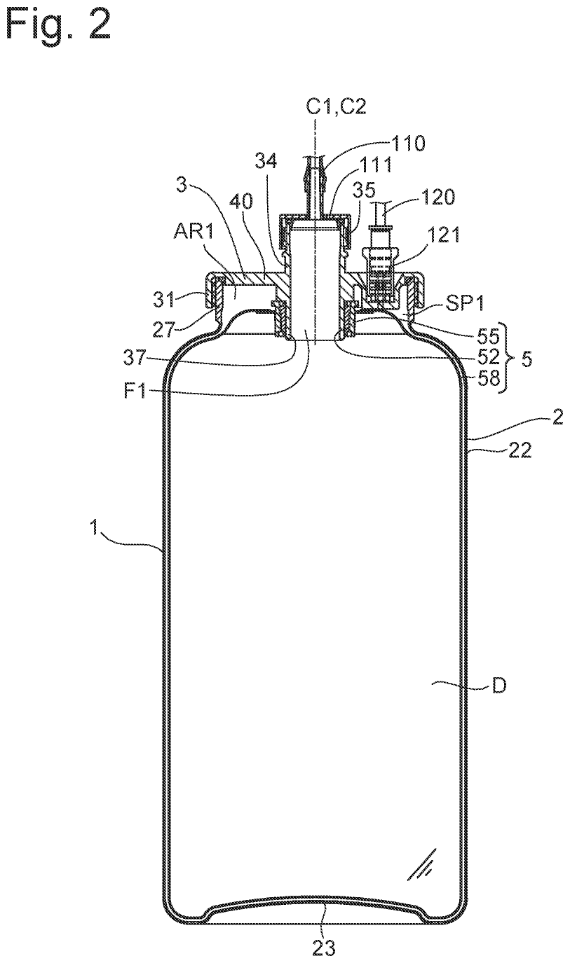

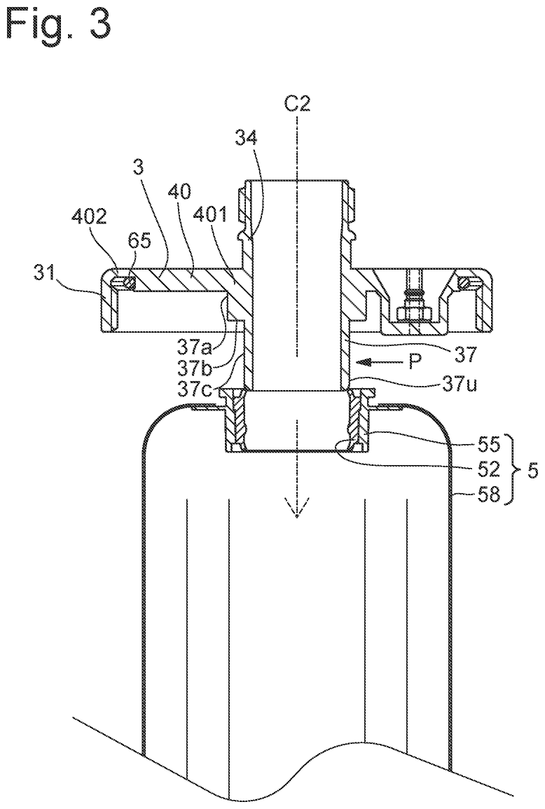

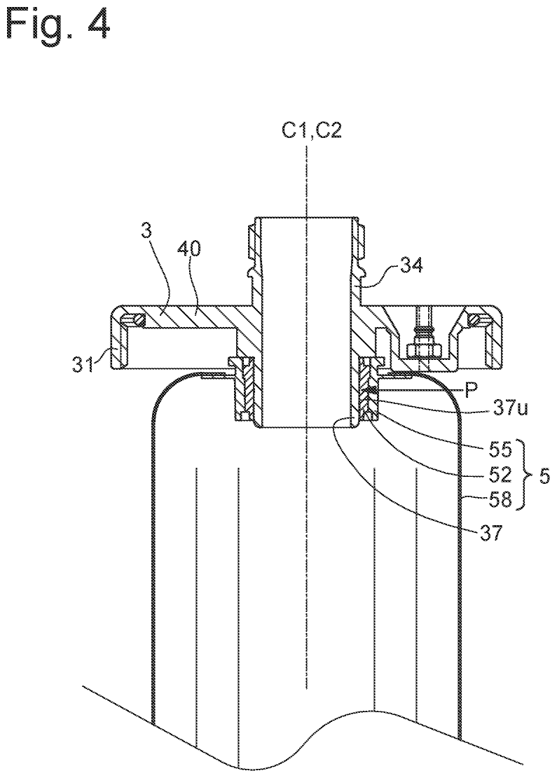

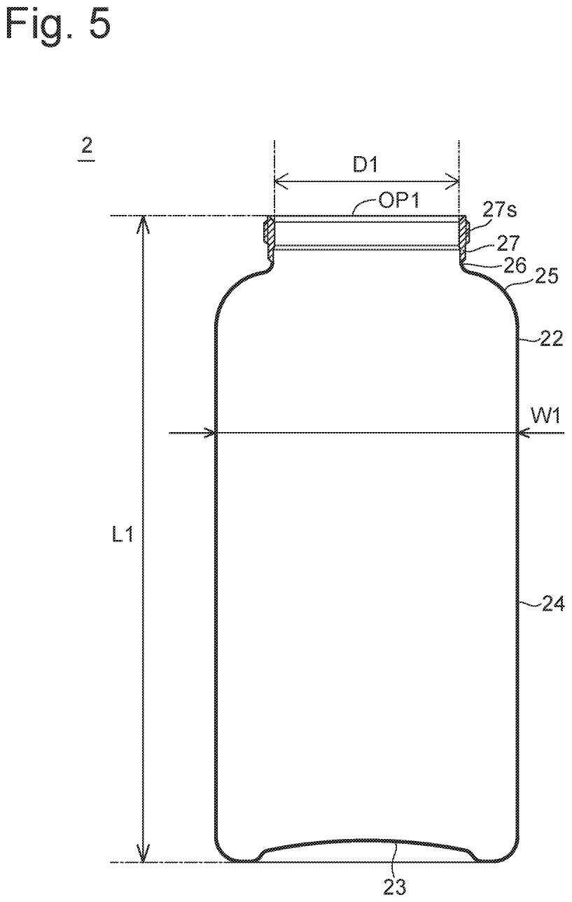

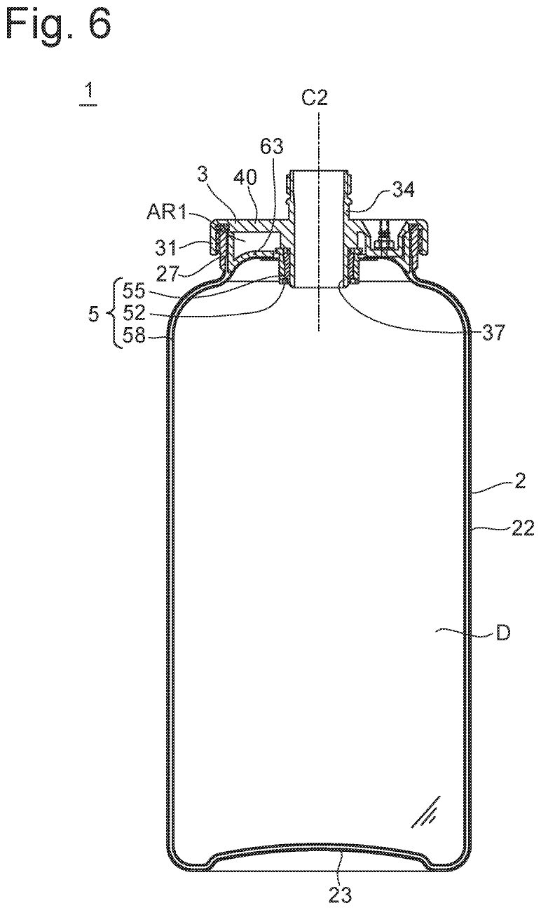

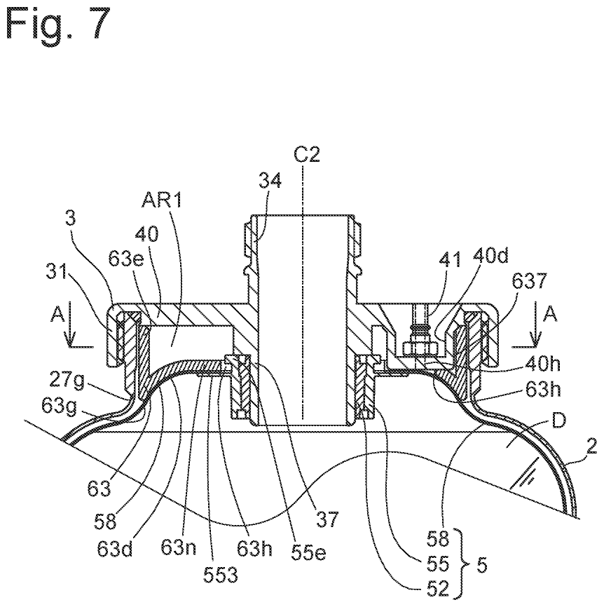

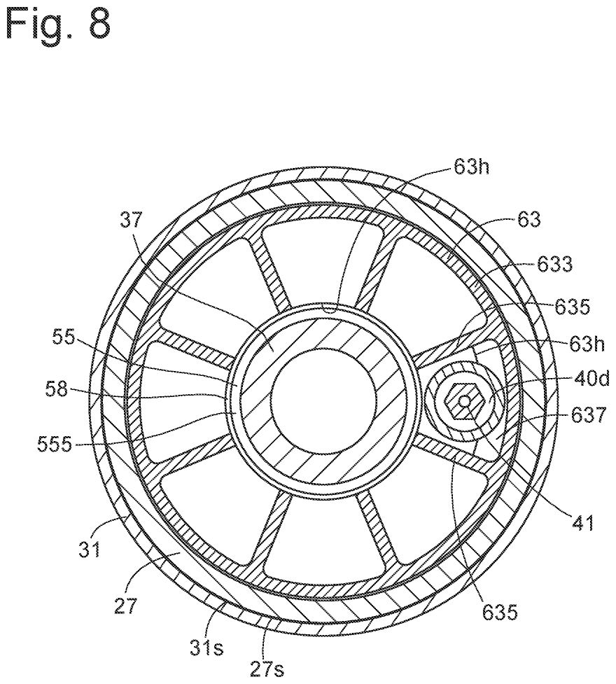

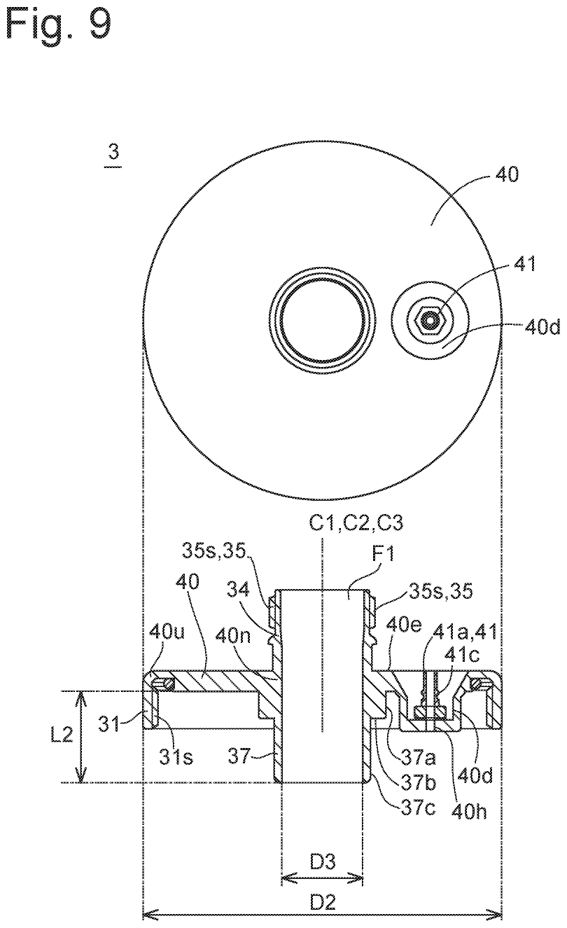

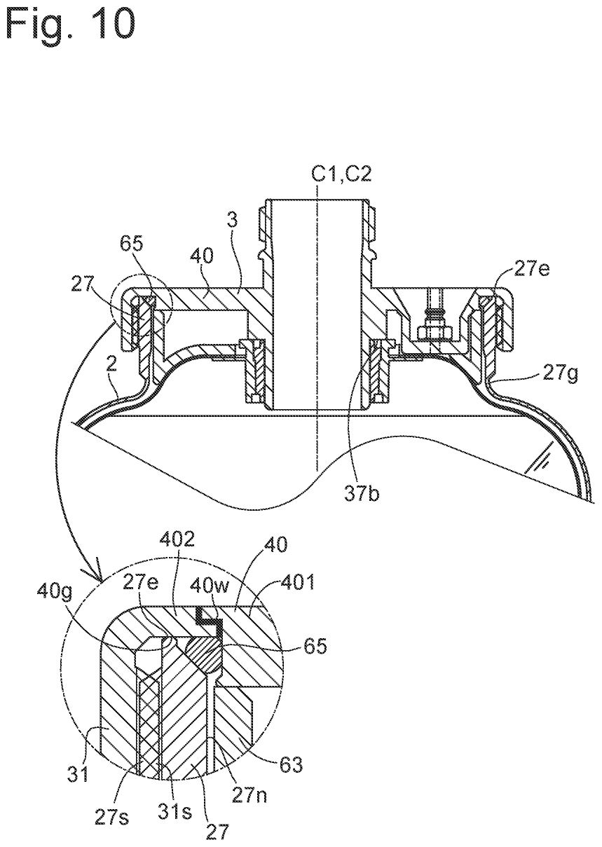

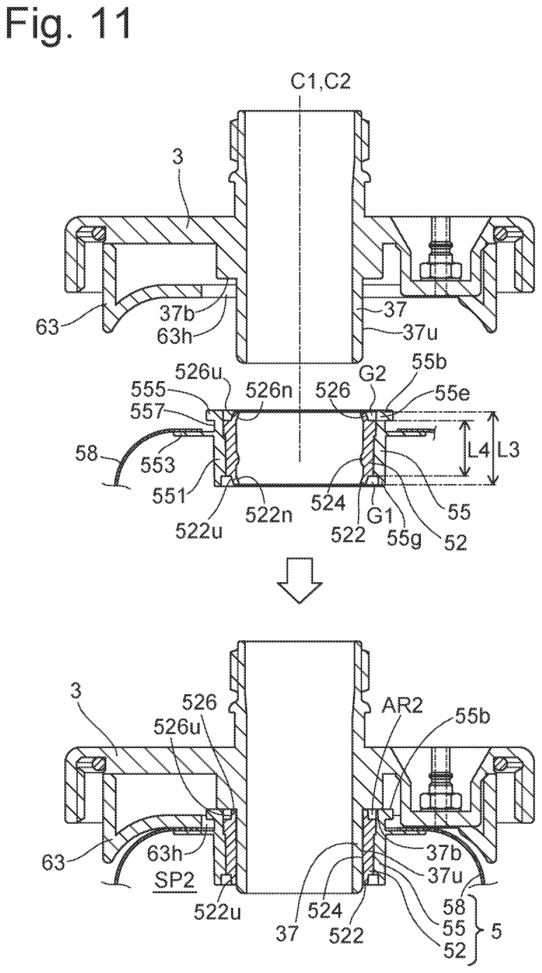

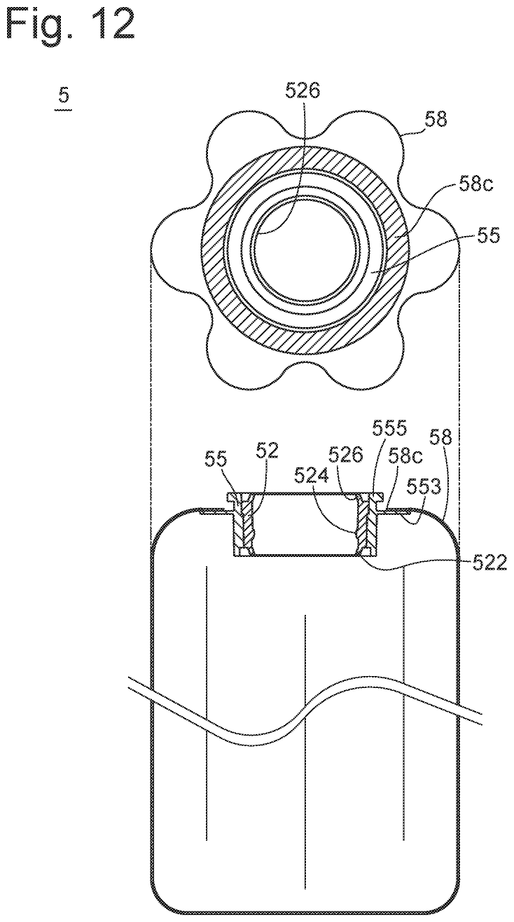

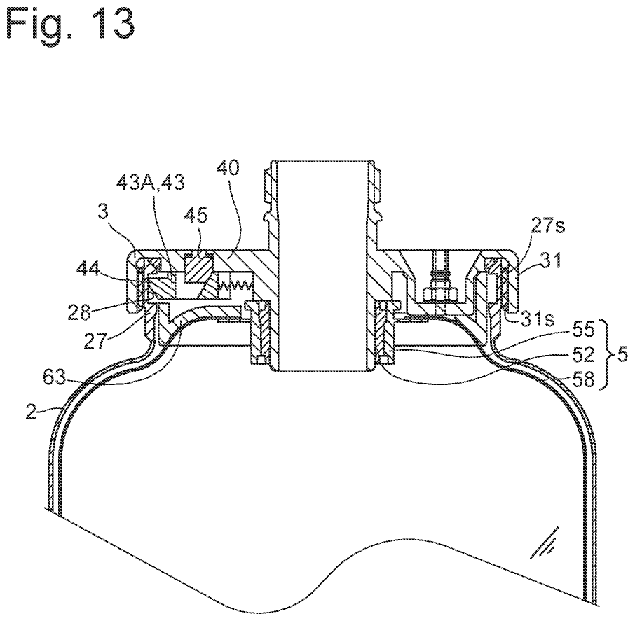

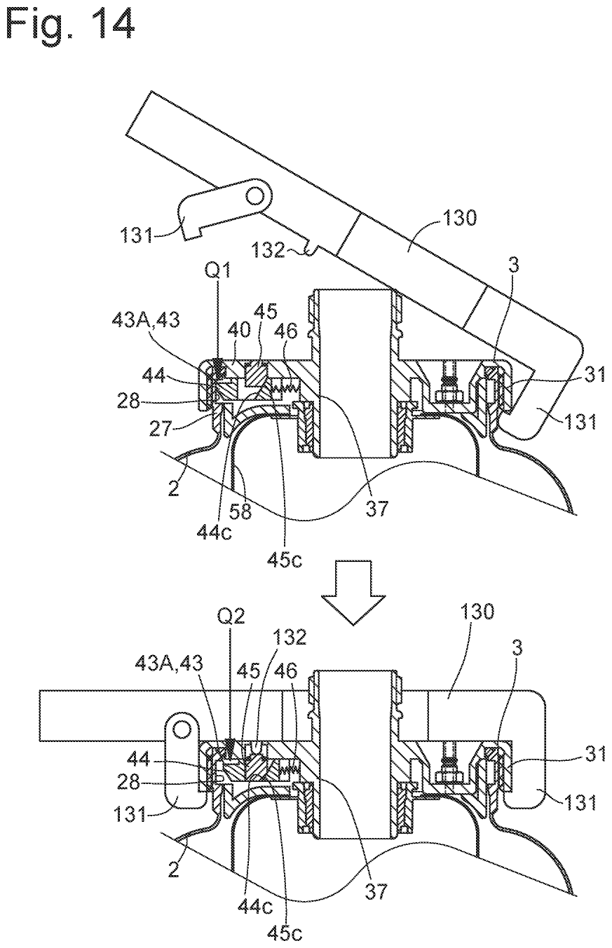

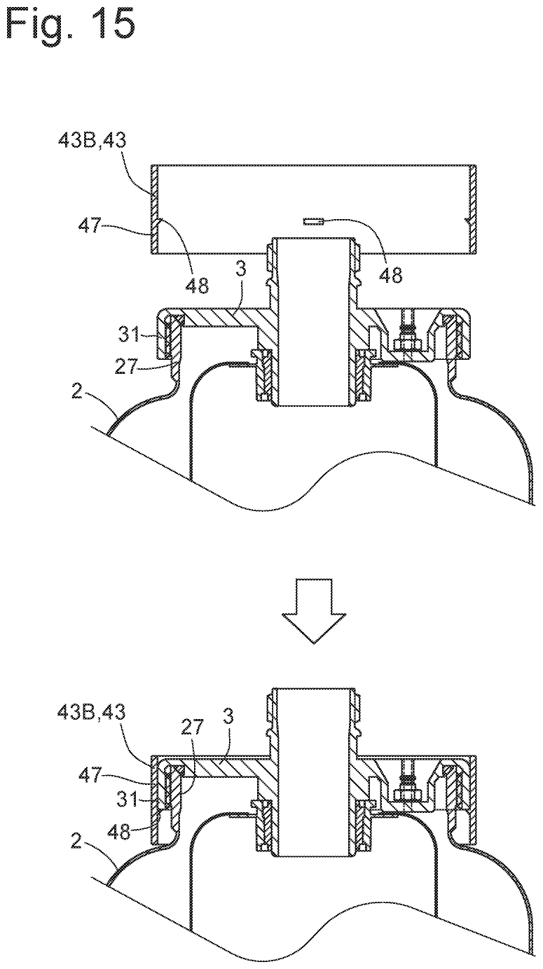

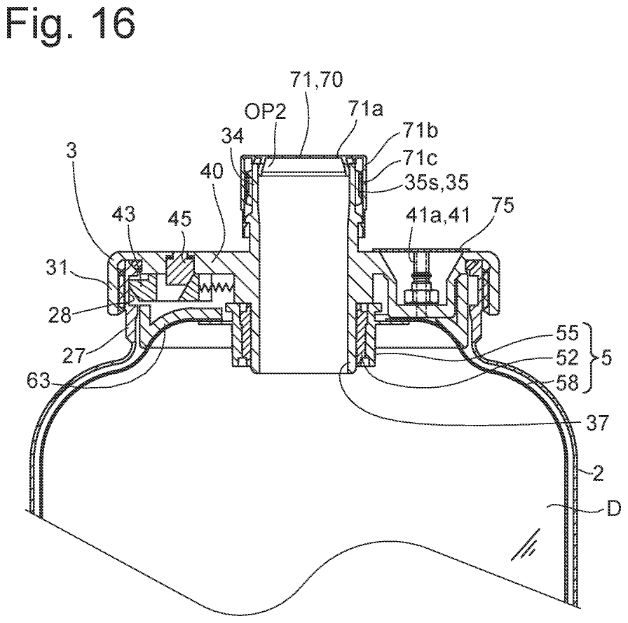

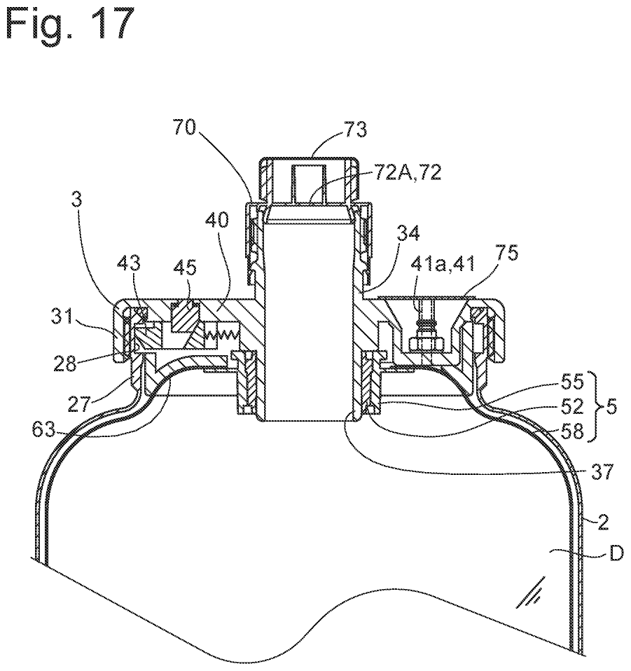

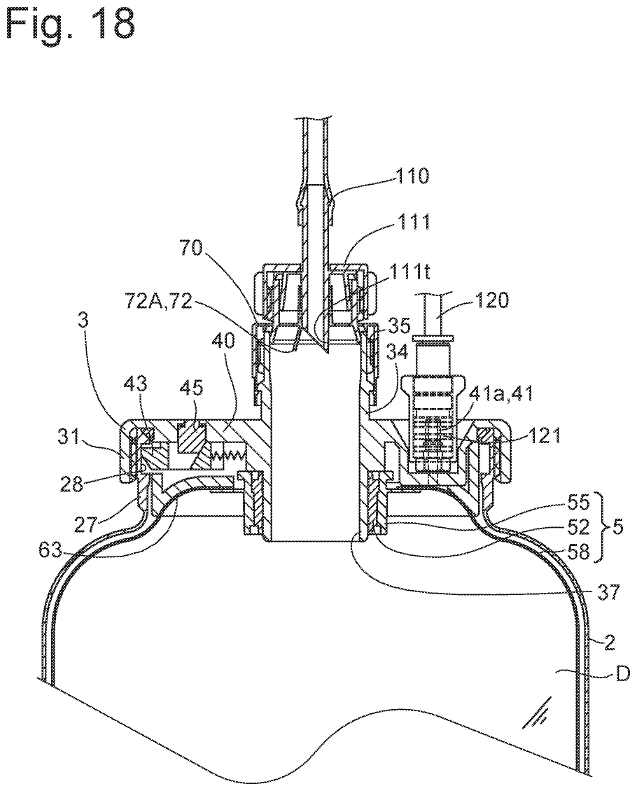

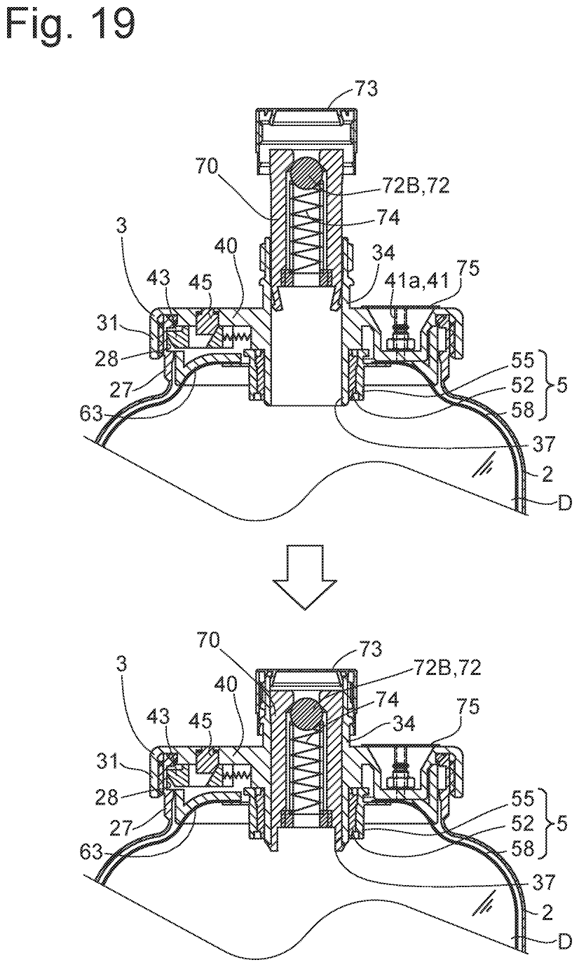

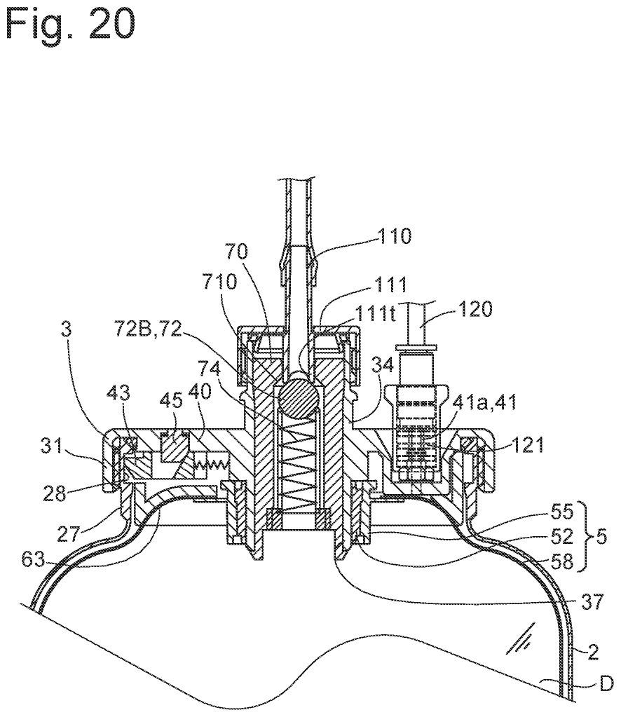

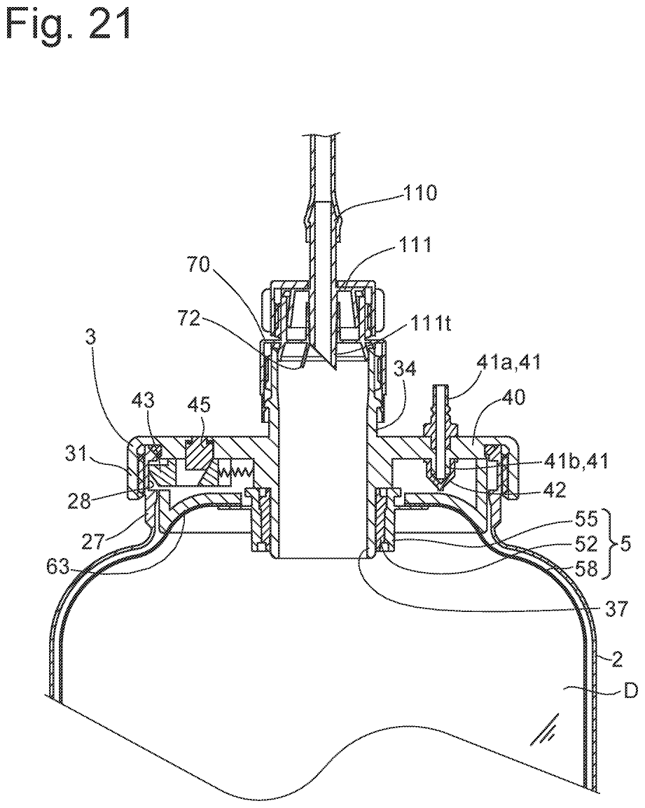

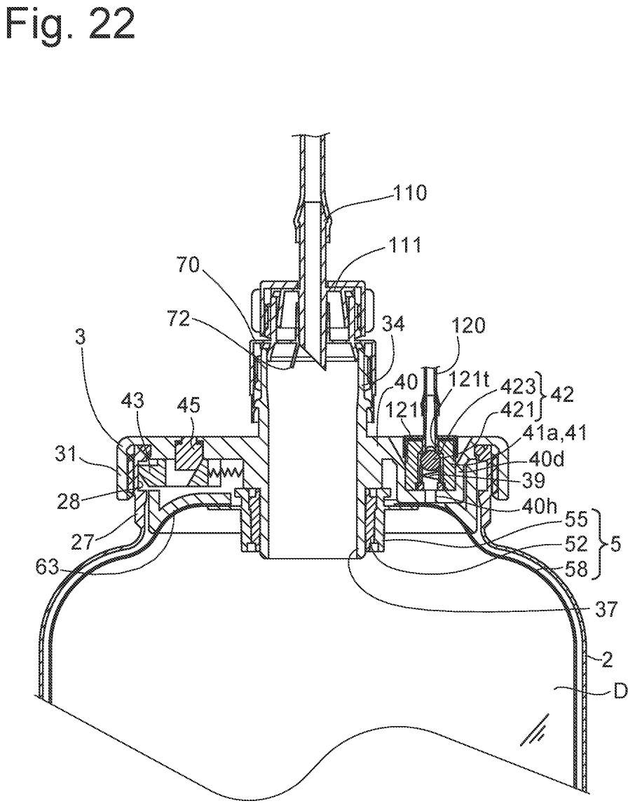

Referring to FIGS. 1 to 22, a beverage container 1 according to a first embodiment will be described. FIG. 1 is a schematic cross-sectional view schematically showing a beverage container 1 according to a first embodiment. Note that, FIG. 1 shows a state before the beverage container 1 is assembled. FIG. 2 is a schematic cross-sectional view schematically showing a state in which a beverage dispenser 110 is connected to the beverage container 1 according to the first embodiment. FIG. 3 is a schematic cross-sectional view schematically showing how a replaceable component 5 is attached to a lower pipe portion 37. FIG. 4 is a schematic cross-sectional view schematically showing a state after the replaceable component 5 is attached to the lower pipe portion 37. FIG. 5 is a schematic cross-sectional view schematically showing an example of an outer container 2. FIG. 6 is a schematic cross-sectional view schematically showing the beverage container 1 according to the first embodiment. FIG. 7 is a schematic cross-sectional view schematically showing a part of the beverage container 1 according to the first embodiment. FIG. 8 is a cross-sectional view taken along the line A-A of FIG. 7. FIG. 9 is a schematic two-view schematically showing an example of a lid member 3. The upper side of FIG. 9 shows a schematic plan view and the lower side of FIG. 9 shows a schematic cross-sectional view. FIG. 10 is a schematic cross-sectional view schematically showing a part of the beverage container 1 according to the first embodiment. FIG. 11 is a diagram for explaining each element of the replaceable component 5. FIG. 12 is a schematic two-view schematically showing an example of the replaceable component 5. The upper side of FIG. 12 shows a schematic plan view, and the lower side of FIG. 12 shows a schematic cross-sectional view. FIG. 13 is a schematic cross-sectional view schematically showing a part of the beverage container 1 according to the first embodiment. FIG. 14 is a diagram for explaining an example of a removal-preventing member 43. FIG. 15 is a diagram for explaining the removal-preventing member 43 according to a first modified example. FIG. 16 is a schematic cross-sectional view schematically showing a state in which a first closure member 70 is attached to the lid member 3. FIG. 17 is a schematic cross-sectional view schematically showing a state in which the first closure member 70 according to a first modified example is attached to the lid member 3. FIG. 18 is a schematic cross-sectional view schematically showing a state after a closing part 72 of the first closure member 70 according to the first modified example moves to an open position. FIG. 19 is a schematic cross-sectional view schematically showing how the first closure member 70 according to a second modified example is attached to the lid member 3. FIG. 20 is a schematic cross-sectional view schematically showing a state after the closing part 72 of the first closure member 70 according to the second modified example moves to the open position. FIG. 21 is a diagram for explaining an example of a gas valve 42. FIG. 22 is a diagram for explaining another example of the gas valve 42.

As shown in FIG. 1, a beverage container 1 includes an outer container 2, a lid member 3 and a replaceable component 5 including a bag 58.

The outer container 2 defines an internal space SP1 in which the replaceable component 5 including the bag 58 is arranged. The outer container 2 has a container main body 22 and a first mouth portion 27. In an example shown in FIG. 1, the first mouth portion 27 extends in an upward direction from the container main body 22. The outer container 2 is, for example, made of metal (more specifically, made of stainless steel). Alternatively, the outer container 2 may be made of resin.

The lid member 3 is attached to the first mouth portion 27 of the outer container 2. In the example shown in FIG. 1, the first mouth portion 27 has a first threaded portion 27s (more specifically, a male threaded portion). The first mouth portion 27 defines a first opening OP1 through which the replaceable component 5 can pass.

The lid member 3 includes an attachment portion 31, an upper pipe portion 34, an annular portion 40 and a lower pipe portion 37.

The attachment portion 31 is attached to the first mouth portion 27 of the outer container 2. In the example shown in FIG. 1, the attachment portion 31 has a second threaded portion 31s (more specifically, a female threaded portion) threadably engaging with the first threaded portion 27s of the first mouth portion 27. The attachment portion 31 is, for example, made of metal (more specifically, made of stainless steel). Alternatively, the attachment portion 31 may be made of resin.

As shown in FIG. 2, the upper pipe portion 34 is arranged outside the outer container 2. A beverage dispenser 110 or a first closure member 70 (see FIG. 16 for example) can be attached to the upper pipe portion 34. In an example shown in FIG. 2, the upper pipe portion 34 extends in the upward direction from the annular portion 40. The upper pipe portion 34 is, for example, made of metal (more specifically, made of stainless steel). Alternatively, the upper pipe portion 34 may be made of resin.

The annular portion 40 extends outward from the upper pipe portion 34 (in other words, the annular portion 40 extends from the upper pipe portion 34 in a direction away from a central axis C1 of the upper pipe portion 34). Also, the annular portion 40 connects the upper pipe portion 34 and the attachment portion 31. In the example shown in FIG. 1, the annular portion 40 has an inner portion 401 connected to the upper pipe portion 34 and an outer portion 402 connected to the attachment portion 31.

Since the lid member 3 has the annular portion 40, the inner diameter of the first mouth portion 27 of the outer container 2 can be made remarkably larger than the inner diameter of the upper pipe portion 34. When the inner diameter of the first mouth portion 27 is large, it is easy to insert the replaceable component 5 having the bag 58 into the outer container 2 through the first mouth portion 27.

As shown in FIG. 2, the lower pipe portion 37 is arranged below the upper pipe portion 34. The inner surface of the lower pipe portion 37 and the inner surface of the upper pipe portion 34 define a beverage flow channel F1.

A lower pipe portion 37 extends in a downward direction from the annular portion 40. In the example shown in FIG. 2, the lower pipe portion 37 extends from the annular portion 40 in the direction toward a bottom portion 23 of the outer container 2. The replaceable component 5 is attached to the lower pipe portion 37. The lower pipe portion 37 is, for example, made of metal (more specifically, made of stainless steel). Alternatively, the lower pipe portion 37 may be made of resin.

The replaceable component 5 is attached to the lower pipe portion 37 and is arranged in the internal space SP1 of the outer container 2. In the example shown in FIG. 2, a whole of the replaceable component 5 is arranged in the internal space SP1 of the outer container 2.

As shown in FIG. 3, the replaceable component 5 includes a sealing member 52, a tubular body 55 and the bag 58. The frequency of replacing the replaceable component 5 is higher than the frequency of replacing the outer container 2 and the lid member 3. By repeatedly reusing the outer container 2 and the lid member 3, the burden on the environment is reduced. When one cycle is defined as from the filling of the beverage into the beverage container 1 to the next filling of the beverage into the beverage container 1, the replaceable component 5 may be replaced every cycle. In other words, the replaceable component 5 may be a one-time use disposable component.

The sealing member 52 is slidable with respect to the lower pipe portion 37. More specifically, the sealing member 52 is slidable in a direction parallel to a central axis C2 of the lower pipe portion 37 with respect to the lower pipe portion 37. In this case, it is easy to move the sealing member 52 toward an installation position P on the lower pipe portion 37 and to arrange the sealing member 52 at the installation position P on the lower pipe portion 37.

At a final stage when the sealing member 52 reaches the installation position P, the sealing member 52 slides with respect to the lower pipe portion 37 in a state where an outer surface 37u of the lower pipe portion 37 and the sealing member 52 are in annular contact with each other. In other words, at the final stage when the sealing member 52 reaches the installation position P, an appropriate frictional resistance is generated between the sealing member 52 and the lower pipe portion 37. Note that if the frictional resistance is too small, the sealing member 52 may be determined to be a defective product.

As shown in FIG. 4, the sealing member 52 is in annular contact with the outer surface 37u of the lower pipe portion 37 when it is located at the installation position P. This contact prevents fluid (in other words, the beverage or a gas) from leaking from between the sealing member 52 and the lower pipe portion 37. The sealing member 52 is made of an elastic material such as rubber.

The tubular body 55 is arranged outside the sealing member 52 and holds the sealing member 52. When the sealing member 52 is located at the installation position P on the lower pipe portion 37, the tubular body 55 prevents an outer diameter of the sealing member 52 from increasing. In this way, the sealing member 52 arranged between the tubular body 55 and the outer surface 37u of the lower pipe portion 37 is compressed, and the sealing effect of the sealing member 52 is improved.

As shown in FIG. 4, the tubular body 55 is supported by the lower pipe portion 37 via the sealing member 52 located at the installation position P. Further, the bag 58 for accommodating the beverage is attached to the tubular body 55.

In an example shown in FIG. 4, when the sealing member 52 is located at the installation position P, the tubular body 55 to which the bag 58 is attached is supported by the lower pipe portion 37 via the sealing member 52. In other words, only by moving the sealing member 52 to the installation position P, the replaceable component 5 including the bag 58 is supported by the lower pipe portion 37. Therefore, the configuration for preventing the replaceable component 5 from falling off from the lower pipe portion 37 is simple.

In the first embodiment, by sliding the sealing member 52 toward the installation position P on the lower pipe portion 37, the replaceable component 5 having the sealing member 52 is attached to the lower pipe portion 37. Therefore, it is easy to attach the replaceable component 5 to the lower pipe portion 37 (see FIGS. 3 and 4).

Moreover, in the first embodiment, the lid member 3 has the annular portion 40. Due to the presence of the annular portion 40, the inner diameter of the first mouth portion 27 of the outer container 2 can be remarkably larger than the inner diameter of the upper pipe portion 34 of the lid member 3. When the inner diameter of the first mouth portion 27 is large, it is easy to insert the replaceable component 5 having the bag 58 into the outer container 2 through the first mouth portion 27 (see FIG. 1).

As mentioned above, in the first embodiment, the beverage container 1 that is easy to assemble is provided.

Subsequently, with reference to FIGS. 1 to 22, optional configurations that can be adopted in the first embodiment will be described.

### (Outer Container 2)

In an example shown in FIG. 5, the outer container 2 is a rigid container (in other words, a container whose shape does not substantially change). The container main body 22 of the outer container 2 has the bottom portion 23 and a body portion 24. The container main body 22 may have a shoulder portion 25 that connects the body portion 24 and the first mouth portion 27. In the example shown in FIG. 5, the shoulder portion 25 and the first mouth portion 27 are connected via a welded portion 26.

In the example shown in FIG. 5, the outer container 2 is a bottle-shaped container. The aspect ratio of the outer container 2 (in other words, the value obtained by dividing the length L1 of the outer container 2 by the maximum width W1 of the outer container 2) is, for example, 1.5 or more, 1.8 or more, or 2.0 or more. Since the maximum width W1 of the outer container 2 is relatively small, the bag 58 arranged inside the outer container 2 has an elongated shape. In this case, it becomes easier to deflate the bag 58 more completely, and the amount of the beverage remaining without being finally taken out of the bag 58 can be reduced. However, the aspect ratio of the outer container 2 is not limited to the above example. In other words, the shape of the outer container 2 does not have to be elongated.

The length L1 of the outer container 2 is, for example, 10 cm or more, 15 cm or more, or 20 cm or more. An inner diameter D1 of the first mouth portion 27 of the outer container 2 is set to a value for allowing the replaceable component 5 to easily pass. The inner diameter D1 of the first mouth portion 27 is, for example, 6 cm or more and 12 cm or less, or 7 cm or more and 10 cm or less. When the inner diameter D1 of the first mouth portion 27 is large, it is easy to insert the replaceable component 5 having the bag 58 into the outer container 2 through the first mouth portion 27. The inner diameter D1 of the first mouth portion 27 may be 0.4 times or larger, 0.5 times or larger, or 0.6 times or larger than the maximum width W1 of the outer container 2. In addition, from the viewpoint of easily inserting the tubular body 55 and the bag 58 attached to the tubular body 55 (see FIG. 1 etc.) into the outer container 2, it is preferable that the inner diameter D1 of the first mouth portion 27 is sufficiently larger than the maximum outer diameter of the tubular body 55 (more specifically, the outer diameter of a first flange 553 described later). The difference between the inner diameter D1 of the first mouth portion 27 and the maximum outer diameter of the tubular body 55 (more specifically, the outer diameter of the first flange 553 described later) is, for example, 15 mm or more, 20 mm or more, or 25 mm or more.

In the example shown in FIG. 1, the first threaded portion 27s of the first mouth portion 27 is a male threaded portion (in other words, an external threaded portion), and the second threaded portion 31s of the attachment portion 31 threadably engaging with the first threaded portion 27s is a female threaded portion (in other words, an internal threaded portion). Since the first threaded portion 27s is a male threaded portion, an inner surface 27n of the first mouth portion 27 can be made smooth. In a case in which the inner surface 27n of the first mouth portion 27 is a smooth surface, the bag 58 is less likely to get caught on the inner surface 27n of the first mouth portion 27, when the replaceable component 5 having the bag 58 is inserted into the outer container 2 through the first mouth portion 27. In this way, the beverage container 1 is easily assembled. Alternatively, the first threaded portion 27s of the first mouth portion 27 may be a female threaded portion, and the second threaded portion 31s of the attachment portion 31 of the lid member 3 may be a male threaded portion.

### (Spacer Member 63)

In an example shown in FIG. 6, the beverage container 1 includes a spacer member 63 arranged between the annular portion 40 and the tubular body 55. The spacer member 63 prevents over-deformation (excessive deformation) of the bag 58 toward the annular portion 40. In the example shown in FIG. 6, the spacer member 63 is not attached to the tubular body 55. In other words, the tubular body 55 is movable relative to the spacer member 63 (more specifically, the tubular body 55 is movable with respect to the spacer member 63 in the direction along the central axis C2 of the lower pipe portion 37). In this case, the spacer member 63 and the replaceable component 5 having the tubular body 55 can be handled separately. For example, the frequency of replacing the spacer member 63 can be made lower than the frequency of replacing the replaceable component 5.

The spacer member 63 is preferably a non-flexible member (in other words, a member whose substantial deformation is suppressed). The spacer member 63 may be made of resin, or may be made of metal such as stainless steel.

In the example shown in FIG. 2, when an internal pressure of the bag 58 increases, a part of the bag 58 enters an annular region AR1 inside the first mouth portion 27, and the bag 58 is over-deformed upward. In addition, the bag 58 may be damaged due to over-deformation of the bag 58. On the other hand, the spacer member 63 prevents the bag 58 from being over-deformed toward the annular portion 40 since the spacer member occupies a part of the annular region AR1 inside the first mouth portion 27. In the example shown in FIG. 6, the spacer member 63 is an annular body arranged between the lower pipe portion 37 and the first mouth portion 27.

In an example shown in FIG. 7, the height of a lower end 63g of the spacer member 63 is substantially equal to the height of a lower end 27g of the first mouth portion 27. In this case, over-deformation of the bag 58 at the boundary between the lower end 63g of the spacer member 63 and the lower end 27g of the first mouth portion 27 is prevented. In the example shown in FIG. 7, the spacer member 63 has an upper end portion 63e located above the lower end 27g of the first mouth portion 27. The upper end portion 63e is arranged in the annular region AR1 between the first mouth portion 27 and the lower pipe portion 37. The upper end portion 63e of the spacer member 63 may be contactable to the annular portion 40 of the lid member 3.

In the example shown in FIG. 7, the spacer member 63 has an inner edge portion 63n that extends inwardly toward the lower pipe portion 37. The inner edge portion 63n of the spacer member 63 may function as a stopper that defines the upper limit position of the first flange 553 of the tubular body 55 of the replaceable component 5.

In the example shown in FIG. 7, the spacer member 63 has a lower surface 63d arranged to face the bag 58. The lower surface 63d is preferably an inclined surface (more specifically, an inclined concave surface) whose height decreases as the distance from the central axis C2 of the lower pipe portion 37 increases. In this case, when the internal pressure of the bag 58 increases, the bag 58 gently deforms along the lower surface 63d of the spacer member 63. As a result, over-deformation of the bag 58 is prevented, and damage to the bag 58 is prevented even more effectively.

In the example shown in FIG. 7, the spacer member 63 has a through hole portion 63h into which the lower pipe portion 37 is inserted. The through hole portion 63h may be able to receive an upper end portion 55e of the tubular body 55 of the replaceable component 5. Also, the inner diameter of the through hole portion 63h of the spacer member 63 may be smaller than the outer diameter of the first flange 553 of the tubular body 55.

In the example shown in FIG. 7, the spacer member 63 is movable relative to the lid member 3. Alternatively, the spacer member 63 may be fixed to the lid member 3. For example, the spacer member 63 may be fixed to the annular portion 40 of the lid member 3 by engagement (for example, thread engagement) or welding.

As shown in FIG. 8, the spacer member 63 may have an outer shell portion 633 and reinforcing ribs 635 arranged inside the outer shell portion 633. The reinforcing ribs 635 reinforce the outer shell portion 633 and suppress deformation of the outer shell portion 633. Also, as shown in FIGS. 7 and 8, the spacer member 63 may have a receiving space 637 capable of receiving a recess portion 40d formed in the annular portion 40. The receiving space 637 is, for example, a space defined by two reinforcing ribs 635 and the outer shell portion 633.

### (Lid Member 3)

The lid member 3 has an annular portion 40 that connects the upper pipe portion 34 and the attachment portion 31. As shown in FIG. 9, the annular portion 40 may connect the attachment portion 31 and the upper pipe portion 34, may connect the attachment portion 31 and the lower pipe portion 37, and may connect the upper pipe portion 34 and the lower pipe portion 37. The upper surface of the annular portion 40 may be a surface parallel to the horizontal plane, or may be a surface inclined with respect to the horizontal plane. The annular portion 40 may be a flange.

In an example shown in FIG. 9, the lid member 3 is a component in which the attachment portion 31, the lower pipe portion 37, the upper pipe portion 34, and the annular portion 40 are integrated. In this case, a whole of the lid member 3 is attached to the outer container 2 by attaching the attachment portion 31 of the lid member 3 to the first mouth portion 27 of the outer container 2. Alternatively, the lid member 3 may be divided into a plurality of components, and each component may be placed to the outer container 2 sequentially.

In the example shown in FIG. 9, the attachment portion 31 extends in the downward direction from an outer edge portion 40u of the annular portion 40. The upper pipe portion 34 extends in the upward direction from an inner edge portion 40n of the annular portion 40. Also, the lower pipe portion 37 extends in the downward direction from the inner edge portion 40n of the annular portion 40. In this case, the inner diameter of the attachment portion 31 can be made remarkably larger than the inner diameter of the upper pipe portion 34 and the inner diameter of the lower pipe portion 37. In the example shown in FIG. 9, the central axis C1 of the upper pipe portion 34, the central axis C2 of the lower pipe portion 37, and the central axis C3 of the attachment portion 31 are arranged on one straight line.

An outer diameter D2 of the annular portion 40 is, for example, two times or larger, three times or larger, or four times or larger than an inner diameter D3 of the annular portion 40. When the difference between the outer diameter D2 of the annular portion 40 and the inner diameter D3 of the annular portion 40 is large, it becomes easier to dispose the replaceable component 5 in the region below the annular portion 40, and the replaceable component 5 is easily inserted into the outer container 2.

In the example shown in FIG. 9, the upper pipe portion 34 has a first connecting portion 35. The first connecting portion 35 can be directly or indirectly connected to a first connector 111 of the beverage dispenser 110 (see FIG. 2 for example). As shown in FIG. 18 etc., the first connecting portion 35 may be connected to the first connector 111 via the first closure member 70. In the example shown in FIG. 9, the first connecting portion 35 includes a third threaded portion 35s (more specifically, a male threaded portion formed on the outer peripheral surface of the upper pipe portion 34).

The size and shape of the first connecting portion 35 may be designed to correspond to the size and shape of the first connector of existing beverage dispensers. For example, the size and shape of the first connecting portion 35 may be designed so as to correspond to a connector that can be connected to a general dispensing head.

In the example shown in FIG. 9, the lid member 3 has a gas pipe portion 41 through which the gas can pass, and a second connecting portion 41c arranged in the gas pipe portion 41. The second connecting portion 41c is connectable to a connector (hereinafter referred to as “second connector”) of the gas supply device.

In the example shown in FIG. 9, the gas pipe portion 41 is arranged in the annular portion 40 of the lid member 3. By completely separating the region where the gas pipe portion 41 is arranged from the region where the upper pipe portion 34 is arranged, each of the structure of the upper pipe portion 34 and the structure of the gas pipe portion 41 can be simplified.

The gas pipe portion 41 may include a first pipe portion 41a arranged outside the outer container 2. Alternatively or additionally, the gas pipe portion 41 may include a second pipe portion exposed to the space within the outer container 2.

In the example shown in FIG. 9, the annular portion 40 has a recess portion 40d recessed in the downward direction with respect to a top surface 40e of the annular portion 40. At least a part of the gas pipe portion 41 is arranged in the recess portion 40d. In this case, at least a part of the gas pipe portion 41 is protected by the wall surface defining the recess portion 40d.

The upper end of the gas pipe portion 41 may be arranged substantially at the same height as the top surface 40e of the annular portion 40, or the upper end of the gas pipe portion 41 may be arranged lower than the top surface 40e of the annular portion 40. In this case, the gas pipe portion 41 is well protected by the annular portion 40. Also, it is easy to cover the gas pipe portion 41 with a closure member such as a closing sheet (if necessary, see a second closure member 75 in FIG. 16).

In the example shown in FIG. 7, a gas inlet port 40h is formed in the bottom wall of the recess portion 40d of the annular portion 40. In addition, the through hole portion 63h of the spacer member 63 is arranged vertically below the gas inlet port 40h. In this case, the gas supplied to the inside of the outer container 2 through the gas inlet port 40h smoothly moves to the region below the spacer member 63.

In the example shown in FIG. 7, the sealing member 52 of the replaceable component 5 is attached to the lower pipe portion 37, and a whole of the replaceable component 5 is supported by the lower pipe portion 37 via the sealing member 52.

In the example shown in FIG. 9, the length L2 of the lower pipe portion 37 is, for example, 5 cm or less, 4 cm or less, or 3 cm or less. In a case in which the lower pipe portion 37 is a short pipe, the bag 58 can be arranged compactly by using the region below the annular portion 40 and the region below the lower pipe portion 37 when the replaceable component 5 is inserted into the outer container 2. However, in this specification, an embodiment in which the lower pipe portion 37 is a long pipe is not excluded.

In the example shown in FIG. 9, the lower pipe portion 37 has a large diameter portion 37a and a small diameter portion 37c. The large diameter portion 37a has a larger outer diameter as compared to the small diameter portion 37c, and the small diameter portion 37c has a smaller outer diameter as compared to the large diameter portion 37a. In the example shown in FIG. 9, the large diameter portion 37a is thicker than the small diameter portion 37c. The inner diameter of the large diameter portion 37a may be the same as the inner diameter of the small diameter portion 37c.

In the example shown in FIG. 3, the sealing member 52 of the replaceable component 5 is attached to the small diameter portion 37c. The outer diameter of the small diameter portion 37c is larger than the minimum inner diameter of the sealing member 52 before being attached to the small diameter portion 37c. Due to the elastic properties of the sealing member 52, the sealing member 52 tries to return to its original shape after being attached to the outer peripheral surface of the small diameter portion 37c. Thus, due to the elastic properties of the sealing member 52, the sealing member 52 is stably held by the small diameter portion 37c. In the example shown in FIG. 3, the outer surface of the small diameter portion 37c is a smooth surface. In this case, the sealing state between the small diameter portion 37c and the sealing member. 52 is well ensured.

In the example shown in FIG. 3, the lower pipe portion 37 has a stopper surface 37b that defines an upper limit position of the tubular body 55. In the example shown in FIG. 3, the stopper surface 37b is formed by a stepped portion between the large diameter portion 37a and the small diameter portion 37c.

When the lower pipe portion 37 has the stopper surface 37b, by sliding the tubular body 55 and the sealing member 52 with respect to the lower pipe portion 37 so that the tubular body 55 contacts the stopper surface 37b, the sealing member 52 can be well attached to the lower pipe portion 37 (more specifically, the small diameter portion 37c). Alternatively or additionally, when the beverage container 1 has the spacer member 63, the tubular body 55 and the sealing member 52 may be slid with respect to the lower pipe portion 37 so that the tubular body 55 (more specifically, the first flange 553 of the tubular body 55) contacts the spacer member 63. In other words, the spacer member 63 may function as a stopper for the tubular body 55.

In an example shown in FIG. 10, the stopper surface 37b is located below the upper surface 27e of the first mouth portion 27 and above the lower end 27g of the first mouth portion 27.

### (Sealing Ring 65)

In the example shown in FIG. 10, the beverage container 1 has a sealing ring 65 arranged between the first mouth portion 27 and the annular portion 40. The sealing ring 65 prevents gas from leaking out from a gap between the outer container 2 and the lid member 3.

In the example shown in FIG. 10, the upper surface 27e of the first mouth portion 27 and a lower surface 40g of the annular portion 40 are in surface-to-surface contact with each other in a state in which the sealing ring 65 is compressed. Due to the surface-to-surface contact, an amount of compression of the sealing ring 65 is maintained at an appropriate value. In other words, damage to the sealing ring 65 due to excessive compression is prevented, and a stable sealing effect by the sealing ring 65 is maintained.

In the example shown in FIG. 10, the inner portion 401 of the annular portion 40 and the outer portion 402 of the annular portion 40 are connected via a welded portion 40w. In a case in which the inner portion 401 and the outer portion 402 are manufactured separately, it is easy to form a groove for receiving the sealing ring 65 in the lower surface 40g of the annular portion 40. The welded portion 40w may have any shape as long as the inner portion 401 of the annular portion 40 and the outer portion 402 of the annular portion 40 can be adequately connected.

### (Sealing Member 52 of the Replaceable Component 5)

In an example shown in FIG. 11 (see the lower drawing), the sealing member 52 of the replaceable component 5 has a lower lip portion 522. The lower lip portion 522 annularly contacts the outer surface 37u of the lower pipe portion 37. Further, the lower lip portion 522 has a first outer peripheral surface 522u to which an internal pressure (hereinafter referred to as “first internal pressure”) inside the bag 58 is applied. The first outer peripheral surface 522u is exposed to a space SP2 inside the bag 58. When the first internal pressure inside the bag 58 increases, a force with which the lower lip portion 522 is pushed toward the lower pipe portion 37 increases. As a result, it is effectively prevented that the fluid (gas or beverage) in the bag 58 leaks from between the sealing member 52 and the lower pipe portion 37.

As shown in FIG. 11 (see the upper drawing), before the sealing member 52 is attached to the lower pipe portion 37, the lower lip portion 522 preferably has an inner surface 522n that inclines inward in a downward direction.

In the example shown in FIG. 11 (see the lower drawing), the sealing member 52 of the replaceable component 5 has an upper lip portion 526. The upper lip portion 526 annularly contacts the outer surface 37u of the lower pipe portion 37. Further, the upper lip portion 526 has a second outer peripheral surface 526u arranged outside the bag 58.

In the example shown in FIG. 11, a top surface 55b of the tubular body 55 and the stopper surface 37b are in contact with each other. On the other hand, when a gap is created between the top surface 55b and the stopper surface 37b, the pressurized gas enters an annular region AR2 between the tubular body 55 and the sealing member 52 through the gap. When the pressure in the annular region AR2 increases, a force with which the second outer peripheral surface 526u of the upper lip portion 526 is pushed toward the lower pipe portion 37 increases. Therefore, even if the pressure in the annular region AR2 increases, the gas does not enter the bag 58 from the annular region AR2.

As shown in FIG. 11 (see the upper drawing), before the sealing member 52 is attached to the lower pipe portion 37, the upper lip portion 526 preferably has an inner surface 526n that inclines inward in an upward direction.

In the example shown in FIG. 11, an annular protruding portion 524 is formed in the inner surface of the sealing member 52 of the replaceable component 5. In a state in which the sealing member 52 is attached to the lower pipe portion 37 (see the lower drawing), the annular protruding portion 524 is positioned between the lower pipe portion 37 and the tubular body 55. The lower pipe portion 37 stably supports the replaceable component 5 via the annular protruding portion 524 that is compressed between the lower pipe portion 37 and the tubular body 55.

In the example shown in FIG. 11, the annular protruding portion 524 is arranged between the lower lip portion 522 and the upper lip portion 526. In this case, multiple seals are ensured between the lower pipe portion 37 and the sealing member 52. For example, even if a sealing failure occurs in at least one of the lower lip portion 522 and the upper lip portion 526, fluid will not leak from the gap between the lower pipe portion 37 and the sealing member 52.

In the example shown in FIG. 11, the sealing member 52 has a tubular shape as a whole. A length L3 of the sealing member 52 in a direction parallel to the central axis C2 of the lower pipe portion 37 is, for example, 8 mm or more. Further, the length L3 of the sealing member 52 is, for example, 30 mm or less. When the length L3 of the sealing member 52 is long, the sealing member 52 is stably held by the lower pipe portion 37. Also, when the length L3 of the sealing member 52 is long, the fluid is less likely to leak from the gap between the lower pipe portion 37 and the sealing member 52. A length L4 of a contact surface between the sealing member 52 and the tubular body 55 in the direction parallel to the central axis C2 of the lower pipe portion 37 is, for example, 6 mm or more. Moreover, the length L3 of the contact surface is, for example, 28 mm or less. Since the length L4 of the contact surface is long, separation of the sealing member 52 from the tubular body 55 is effectively prevented. It is preferable that the sealing member 52 is firmly fixed to the tubular body 55.

### (Tubular Body 55)

The tubular body 55 is arranged outside the sealing member 52 and holds the sealing member. The elastic modulus of the tubular body 55 is higher than that of the sealing member 52. It is preferable that the tubular body 55 is constituted by an inflexible member (in other words, a member whose substantial deformation is suppressed). The tubular body 55 is made of, for example, synthetic resin such as polyethylene or polypropylene. The tubular body 55 and the sealing member 52 are integrally formed within a mold, for example. Alternatively, the tubular body 55 and the sealing member 52 may be molded separately, and then the sealing member 52 may be attached to the tubular body 55.

In the example shown in FIG. 11 (see the lower drawing), in a state in which the sealing member 52 is attached to the lower pipe portion 37, the inner peripheral surface of the tubular body 55 is maintained in a non-contact state with the lower pipe portion 37. In other words, of the inner peripheral surface of the tubular body 55 and the inner peripheral surface of the sealing member 52, only the inner peripheral surface of the sealing member 52 is in contact with the lower pipe portion 37. In this case, the sealing effect of the sealing member 52 is maximized.

As shown in FIG. 11 (see the upper drawing), a lower end portion 55g of the tubular body 55 may cover the lower lip portion 522 via a gap G1. In this case, part or all of the lower lip portion 522 is protected by the lower end portion 55g of the tubular body 55, and unintended damage to the lower lip portion 522 is prevented or suppressed.

An upper end portion 55e of the tubular body 55 may cover the upper lip portion 526 via a gap G2. In the example shown in FIG. 11, the top surface 55b of the tubular body 55 is located above the upper end of the upper lip portion 526. In this case, a whole of the upper lip portion 526 is protected by the upper end portion 55e of the tubular body 55, and unintended damage to the upper lip portion 526 is prevented or suppressed.

In the example shown in FIG. 11 (see the upper drawing), the tubular body 55 has a tubular portion 551 and the first flange 553. Additionally, the tubular body 55 may have a second flange 555 and an annular groove 557.

The tubular portion 551 is a portion that holds the sealing member 52. The tubular portion 551 holds the sealing member 52 and prevents excessive deformation of the sealing member 52. The tubular portion 551 extends in a direction parallel to the central axis C2 of the lower pipe portion 37. The length of the tubular portion 551 in the direction parallel to the central axis C2 of the lower pipe portion 37 may be longer than the length L3 of the sealing member 52, may be shorter than the length L3 of the sealing member 52, or may be substantially the same as the length L3 of the sealing member 52.

The first flange 553 functions as an attached portion (more specifically, a welded portion) to which the bag 58 is attached. Welding between the first flange 553 and the bag 58 is, for example, high frequency welding. Alternatively, welding between the first flange 553 and the bag 58 may be heat welding or ultrasonic welding. In the example shown in FIG. 11, the bag 58 is welded to an upper surface of the first flange 553. Alternatively, the bag 58 may be welded to a lower surface of the first flange 553. The first flange 553 has an inner edge connected to the tubular portion 551 and an outer edge that is a free edge.

The second flange 555 is arranged above the first flange 553. In the example shown in FIG. 11, an outer diameter of the second flange 555 is smaller than an outer diameter of the first flange 553. In this case, when the bag 58 is attached to the first flange 553, the second flange 555 is unlikely to be an obstacle. The second flange 555 has an inner edge connected to the tubular portion 551 and an outer edge that is a free edge.

The annular groove 557 is arranged between the first flange 553 and the second flange 555.

The second flange 555 and/or annular groove 557 is a portion that is held or gripped by a machine or jig. The presence of the second flange 555 (or the annular groove 557) makes the manufacturing of the replaceable component 5 and/or the transportation of the replaceable component 5 easy.

### (Bag 58)

The bag 58 is attached to the tubular body 55. In an example shown in FIG. 12, a mouth portion 58c (a portion indicated by hatching) of the bag 58 is attached to the first flange 553 of the tubular body 55. The bag 58 is arranged in the inner space of the outer container 2 while attached to the tubular body 55. The bag 58 contains a beverage D (for example, an alcoholic beverage such as beer, or a sparkling beverage such as beer or non-alcoholic beer). The bag 58 can be filled with the beverage, and the beverage can be taken out of the bag 58.

The bag 58 is made of, for example, synthetic resin such as polyethylene or polypropylene. The bag 58 may be composed of any one of a high-density polyethylene layer, a low-density polyethylene layer, a polyethylene terephthalate layer, and a nylon layer, or may be composed of a laminate of these layers. Further, the bag 58 may be constituted by a laminated film in which a light-shielding layer or an oxygen barrier layer such as aluminum foil or an aluminum vapor deposition layer is placed between a plurality of synthetic resin layers in order to ensure light-shielding property and/or oxygen barrier property. Further, the bag 58 may be constituted by a laminated film in which an oxygen barrier layer such as an ethylene-vinyl alcohol copolymer is placed between a plurality of synthetic resin layers. The bag 58 may be constituted by a laminated film including a nylon layer, a polyethylene layer, and an aluminum layer. Note that, the material of the bag 58 is not limited to the above-mentioned examples.

### (Removal-Preventing Member 43)

In an example shown in FIG. 13, the beverage container 1 has a removal-preventing member 43 that prevents the lid member 3 from being removed from the outer container 2.

The lid member 3 itself may have a removal-preventing member 43A that prevents the lid member 3 from being removed from the outer container 2. In the example shown in FIG. 13, the removal-preventing member 43A has an engaging member 44 that is engageable with the outer container 2. The engaging member 44 may be engageable with an engaging portion 28 (for example, an engaging recess) formed in the inner peripheral surface of the first mouth portion 27 of the outer container 2.

As shown in FIG. 14, the engaging member 44 is repositionable between an engaging position Q1 in which it engages with the engaging portion 28 of the outer container 2 and a retracted position Q2 in which it retreats from the engaging portion 28 of the outer container 2. The lid member 3 cannot be removed from the outer container 2 when the engaging member 44 is in the engaging position Q1. On the other hand, the lid member 3 can be removed from the outer container 2 when the engaging member 44 is in the retracted position Q2.

The removal-preventing member 43A may have an operating member 45 for operating the engaging member 44. In an example shown in FIG. 14, the operating member 45 is arranged in the annular portion 40 of the lid member 3.

In the example shown in FIG. 14, the engagement between the outer container 2 and the engaging member 44 is released by pushing the operating member 45 in the downward direction. More specifically, when the operating member 45 is pushed in the downward direction, the engaging member 44 moves from the engaging position Q1 to the retracted position Q2. Further, when the downward force to the operating member 45 is released, the engaging member 44 returns from the retracted position Q2 to the engaging position Q1. In this case, the lid member 3 cannot be removed from the outer container 2 unless the operating member 45 is pushed in the downward direction. Therefore, the lid member 3 is prevented from being removed from the outer container 2 without using a special removal tool 130. In the example shown in FIG. 14, the removal tool 130 for removing the lid member 3 from the outer container 2 has a holding portion 131 that holds the lid member 3 (more specifically, the attachment portion 31) and a pushing portion 132 (more specifically, a pushing protrusion) that pushes the operating member 45. Needless to say, the shape and structure of the removal tool 130 are not limited to the example shown in FIG. 14.

The removal-preventing member 43A preferably has a conversion mechanism that converts downward movement of the operating member 45 into movement of the engaging member 44.

In the example shown in FIG. 14, the engaging member 44 has an inclined surface 44c, and the operating member 45 has a pressing surface 45c (for example, a second inclined surface) that presses the inclined surface 44c. In this case, when the operating member 45 is moved downward, the pressing surface 45c presses the inclined surface 44c. As a result, the engaging member 44 having the inclined surface 44c moves from the engaging position Q1 to the retracted position Q2.

In the example shown in FIG. 14, the conversion mechanism that converts the downward movement of the operating member 45 into the movement of the engaging member 44 is a cam mechanism including the inclined surface 44c and the pressing surface 45c. Alternatively, the conversion mechanism may be a link mechanism having at least one swingable arm.

The removal-preventing member 43A may have a biasing member 46 that biases the engaging member 44 in a direction from the retracted position Q2 toward the engaging position Q1. In the example shown in FIG. 14, the biasing member 46 is arranged on the lid member 3. More specifically, the biasing member 46 is arranged between the engaging member 44 and the lower pipe portion 37.

In the example shown in FIG. 13, the spacer member 63 prevents the bag 58 from directly contacting the removal-preventing member 43A. A portion of the removal-preventing member 43A (for example, the engaging member 44) may be arranged across the spacer member 63.

(First Modified Example of the Removal-Preventing member 43)

In the example shown in FIG. 13, the lid member 3 itself has the removal-preventing member 43A that prevents the lid member 3 from being removed from the outer container 2. On the other hand, in an example shown in FIG. 15, the beverage container 1 is provided with a removal-preventing member 43B that is separate from the lid member 3.

In the example shown in FIG. 15, the removal-preventing member 43B includes an annular member 47 that covers the outer peripheral surface of the attachment portion 31. The annular member 47 prevents the attachment portion 31 of the lid member 3 from being removed from the first mouth portion 27 of the outer container 2 by preventing access to the outer peripheral surface of the attachment portion 31.

In the example shown in FIG. 15, the annular member 47 includes an engaging portion 48 that is engageable with the lid member 3 (more specifically, the attachment portion 31). The annular member 47 cannot be removed from the lid member 3 when the engaging portion 48 is engaged with the lid member 3. In the example shown in FIG. 15 (see the lower drawing), when the annular member 47 is rotated, the annular member 47 idles with respect to the lid member 3. In this case, the lid member 3 is not removed from the first mouth portion 27 of the outer container 2 even if the annular member 47 is rotated. As described above, the lid member 3 is prevented from being removed from the outer container 2 without using a special removal tool or the like.

The annular member 47 preferably does not have weakened portions for breaking the annular member 47. In this case, it is effectively prevented that the lid member 3 is removed from the outer container 2 without using the special removal tool or a special breaking tool. However, in this specification, an embodiment in which the annular member 47 is provided with a weakened portion is not excluded.

### (First Closure Member 70)

As shown in FIG. 16, the beverage container 1 may have a first closure member 70 capable of closing the opening of the upper pipe portion 34 (hereinafter referred to as a “second opening OP2”). In an example shown in FIG. 16, the first closure member 70 is attached to the upper pipe portion 34 after the beverage container 1 (more specifically, the bag 58) is filled with a beverage. By attaching the first closure member 70 to the upper pipe portion 34, entry of external air into the beverage container 1 (more specifically, into the bag 58) is prevented.

In the example shown in FIG. 16, the first closure member 70 is a cap 71. The cap 71 may have a top plate 71a, an annular wall 71b extending in a downward direction from the top plate 71a, and a female threaded portion 71c formed in the annular wall 71b. The female threaded portion 71c is threadably engaging with the third threaded portion 35s formed in the first connecting portion 35 of the upper pipe portion 34.

The cap 71 may be made of resin, or may be made of metal. Note that the first closure member 70 is not limited to the cap 71. The first closure member 70 may be a plug, a crown, or a closure seal.

### (Second Closure Member 75)

As shown in FIG. 16, the beverage container 1 may have a second closure member 75 that covers the gas pipe portion 41. In the example shown in FIG. 16, the second closure member 75 is a closure sheet. Alternatively, the second closure member 75 may be a cap or a plug.

### (First Modified Example of the First Closure Member 70)

In an example shown in FIG. 17, the first closure member 70 has a closing part 72 movable from a closed position that prohibits the beverage D from being taken out of the bag 58 to an open position that allows the beverage D to be taken out of the bag 58. When the closing part 72 is pushed or broken by the first connector 111 of the beverage dispenser 110, it moves from the above-mentioned closed position to the above-mentioned open position.

In the example shown in FIG. 17, the closing part 72 is a closing part 72A (for example, a plate or a sheet) breakable by the first connector 111 of the beverage dispenser 110. The closing part 72A may be covered by a protective member 73 (for example, a protective seal) removable from the first closure member 70.

The closing part 72A is broken by, for example, a tip portion 111t of the first connector 111 (see FIG. 18). The closing part 72A moves from the closed position to the open position by being broken.

In an example shown in FIG. 18, the first closure member 70 is a cap having the closing part 72A. Alternatively, the first closure member 70 may be a plug having the closing part 72A.

### (Second Modified Example of the First Closure Member 70)

In an example shown in FIG. 19, the first closure member 70 has the closing part 72 movable from the closed position that prohibits the beverage from being taken out of the bag 58 to the open position that allows the beverage to be taken out of the bag 58. The closing part 72 moves from the above-mentioned closed position to the above-mentioned open position when being pushed by the first connector 111 of the beverage dispenser 110.

In the example shown in FIG. 19, the closing part 72 is a first valve body 72B that can be pushed by the first connector 111 of the beverage dispenser 110. The first valve body 72B may be covered with the protective member 73 (for example, a protective cap) removable from the first closure member 70.

The first valve body 72B is pushed by, for example, the tip portion 111t of the first connector 111 of the beverage dispenser 110. In an example shown in FIG. 20, the first valve body 72B moves away from a first valve seat portion 710 of the first closure member 70 when the first valve body 72B is pushed by the tip portion 111t of the first connector 111. In this way, the first valve body 72B moves from the closed position to the open position.

The first closure member 70 may have a biasing member 74 (for example, a spring) that biases the first valve body 72B toward the first valve seat portion 710. In this case, when a push on the first valve body 72B is released, the closing part 72 automatically returns from the open position to the closed position.

In the example shown in FIG. 20, the first closure member 70 is a plug having the first valve body 72B. Alternatively, the first closure member 70 may be a cap having the first valve body 72B.

### (Gas Valve 42)

In an example shown in FIG. 21, the lid member 3 includes a gas valve 42 in addition to the gas pipe portion 41. The gas valve 42 is a valve that can change its state between an open state in which the outside of the lid member 3 and the inside of the lid member 3 are in fluid communication, and a closed state in which the outside of the lid member 3 and the inside of the lid member 3 are not in fluid communication.

In the example shown in FIG. 21, the gas pipe portion 41 is arranged in the annular portion 40 and the gas valve 42 is arranged in the gas pipe portion 41. More specifically, the gas pipe portion 41 has a second pipe portion 41b exposed to a space inside the outer container 2, and the gas valve 42 is arranged in the second pipe portion 41b.

In the example shown in FIG. 21, the gas valve 42 is a check valve that allows gas to move from the outside of the lid member 3 to the inside of the lid member 3 and prohibits the gas from moving from the inside of the lid member 3 to the outside of the lid member 3. In this case, the gas can be supplied from the outside of the lid member 3 to the inside of the lid member 3 by making a gas supply pressure to the gas pipe portion 41 higher than an internal pressure of the outer container 2. Further, when the gas supply device is removed from the gas pipe portion 41, the gas valve 42 is automatically closed by the internal pressure of the outer container 2.

Alternatively, as shown in FIG. 22, the gas valve 42 may be a valve that allows gas to move from the outside of the lid member 3 to the inside of the lid member 3 and allows the gas to move from the inside of the lid member 3 to the outside of the lid member 3.

In an example shown in FIG. 22, the gas valve 42 includes a second valve body 421 arranged inside the gas pipe portion 41 and a second valve seat portion 423 arranged in the gas pipe portion 41. The second valve body 421 can be pushed by a second connector 121 of the gas supply device 120. The second valve body 421 is separated from the second valve seat portion 423 when the second valve body 421 is pushed by a tip portion 121t of the second connector 121. In this way, a state of the gas valve 42 is switched from a closed state to an open state.

The lid member 3 may have a biasing member 39 (for example, a spring) that biases the second valve body 421 toward the second valve seat portion 423. In this case, when a push against the second valve body 421 is released, the state of the gas valve 42 automatically returns from the open state to the closed state.

In the example shown in FIG. 22, the second valve body 421 and the biasing member 39 are arranged inside the first pipe portion 41a that is arranged outside the outer container 2.

### Second Embodiment

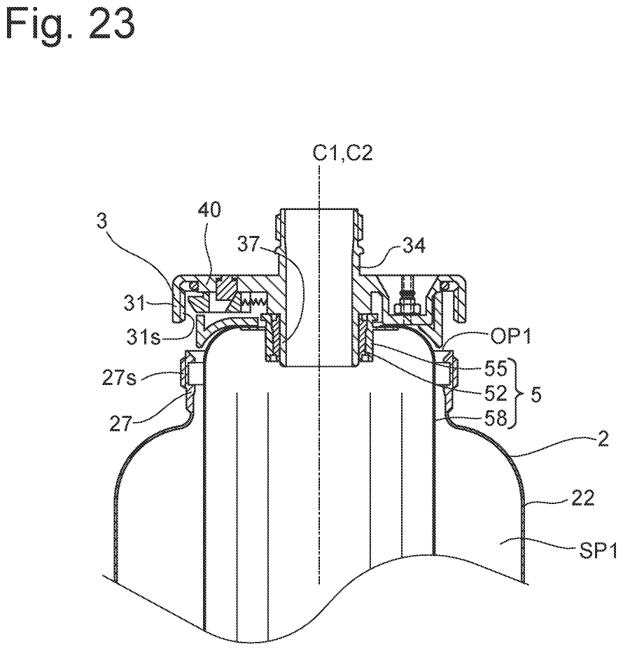

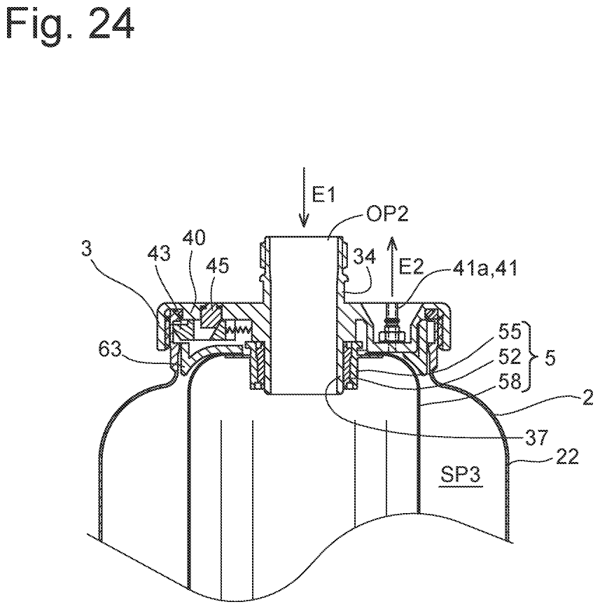

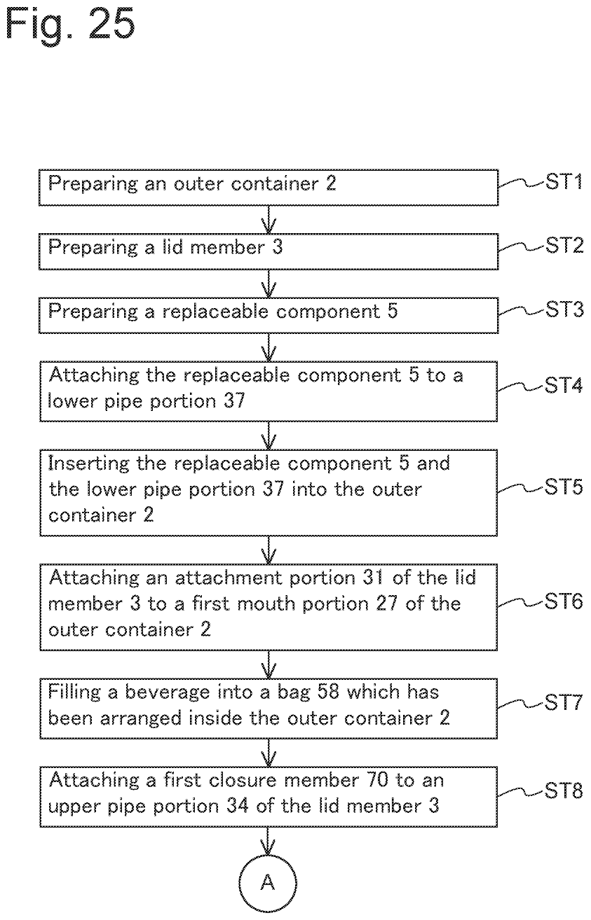

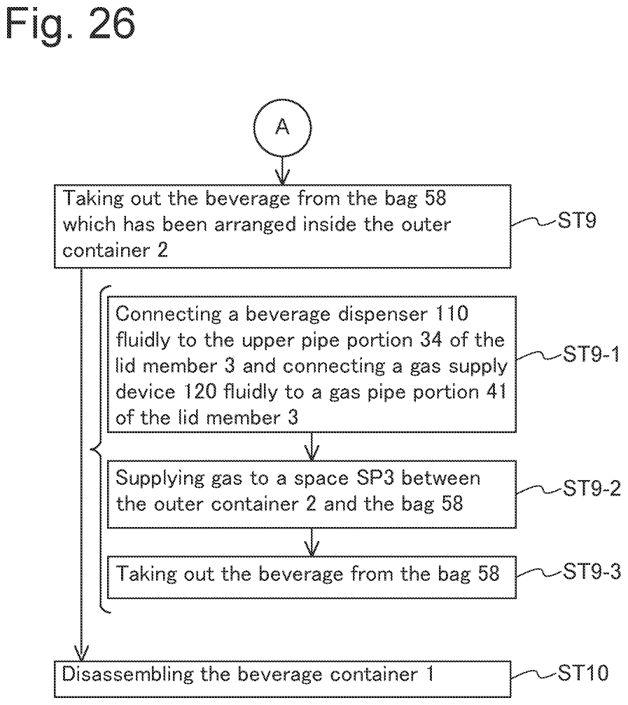

A method of assembling a beverage container 1 according to a second embodiment will be described with reference to FIGS. 1 to 26. FIG. 23 is a schematic cross-sectional view schematically showing a state during execution of an inserting step. FIG. 24 is a schematic cross-sectional view schematically showing a state during execution of a beverage filling step. FIG. 25 is a flow chart showing an example of a method of assembling a beverage container according to the second embodiment. FIG. 26 is a flow chart showing an example of a method of handling a beverage container according to the second embodiment.

A method of assembling a beverage container according to the second embodiment constitutes a part of a method of handling a beverage container according to the second embodiment. A beverage container 1 assembled by the method of assembling a beverage container according to the second embodiment may be the beverage container 1 according to the first embodiment, or may be another beverage container. Since each component of the beverage container 1 has already been described in the first embodiment, repeated description of each component of the beverage container 1 will be omitted.

In a first step ST1, an outer container 2 having a container main body 22 and a first mouth portion 27 is prepared (see FIG. 5, for example). The first step ST1 is a first preparing step. The outer container 2 prepared in the first preparing step is preferably a rigid container (for example, a container made of stainless steel). The outer container 2 may be a new container or a reused container prepared by disassembling a beverage container collected from a user.

In a second step ST2, a lid member 3 is prepared. The second step ST2 is a second preparing step. The lid member 3 prepared in the second preparing step may be a new lid member 3 or a reused product prepared by disassembling the beverage container collected from the user.

As shown in FIG. 9, the lid member 3 prepared in the second preparing step includes (1) an attachment portion 31 attachable to the first mouth portion 27, (2) an upper pipe portion 34 arranged outside the outer container 2, (3) an annular portion 40 extending outward from the upper pipe portion 34 and connecting the upper pipe portion 34 and the attachment portion 31, and (4) a lower pipe portion 37 extending downward from the annular portion 40.

The lid member 3 prepared in the second preparing step may have a gas pipe portion 41 arranged in the annular portion 40. The lid member 3 may have a gas valve 42 (see FIG. 21, FIG. 22, etc.) arranged in the gas pipe portion 41. Also, the lid member 3 prepared in the second preparing step may have a removal-preventing member 43 (see FIG. 13, etc.).

In a third step ST3, a replaceable component 5 is prepared. The third step ST3 is a third preparing step. The replaceable component 5 prepared in the third preparing step is a new component.

As shown in FIG. 12, the replaceable component 5 has (1) a sealing member 52, (2) a tubular body 55 holding the sealing member 52, and (3) a bag 58 for containing a beverage attached to the tubular body 55.

The first step ST1 (the first preparing step), the second step ST2 (the second preparing step), and the third step ST3 (the third preparing step) may be executed in any order.

In a fourth step ST4, the replaceable component 5 is attached to the lower pipe portion 37. The fourth step ST4 is a first attaching step. As shown in FIG. 3 etc., the first attaching step includes sliding the sealing member 52 and the tubular body 55 with respect to the lower pipe portion 37. In this specification, “slide” means relative sliding of the sealing member 52 with respect to the lower pipe portion 37. Therefore, “slide” includes linear movement of the sealing member 52 with respect to the lower pipe portion 37, and linear movement of the lower pipe portion 37 with respect to the sealing member 52.

In the example shown in FIG. 3, the lower pipe portion 37 has a large diameter portion 37a, a small diameter portion 37c, and a stopper surface 37b arranged between the large diameter portion 37a and the small diameter portion 37c. In this case, the sealing member 52 is attached to the small diameter portion 37c in the first attaching step. Further, the stopper surface 37b prevents the tubular body 55 of the replaceable component 5 from moving upward beyond the stopper surface 37b.

As shown in FIG. 4, the first attaching step includes making the sealing member 52 into annular contact with an outer surface 37u of the lower pipe portion 37 at an installation position P.

The first attaching step includes attaching the sealing member 52 to the lower pipe portion 37 using a frictional force acting between the sealing member 52 and the outer surface 37u of the lower pipe portion 37. Since the replaceable component 5 and the lower pipe portion 37 are not glued or welded to each other, it is easy to remove the replaceable component 5 from the lower pipe portion 37 after the beverage container is collected.

As shown in FIG. 11, in the first attaching step, the sealing member 52 may be attached to the lower pipe portion 37 at a position below a spacer member 63. More specifically, the lower pipe portion 37 may be inserted into a through hole portion 63h of the spacer member 63, and the sealing member 52 may then be attached to the lower pipe portion 37 at the position below the spacer member 63. Alternatively, in the second preparing step (the second step ST2), the lid member 3 with the spacer member 63 may be prepared, and in the first attaching step (the fourth step ST4), the sealing member 52 may be attached to the lower pipe portion 37 at the position below the spacer member 63.

As shown in FIG. 23, in a fifth step ST5, the replaceable component 5 and the lower pipe portion 37 are inserted into the outer container 2. The fifth step ST5 is an inserting step. More specifically, the inserting step includes inserting the lower pipe portion 37, the sealing member 52 attached to the lower pipe portion 37, the tubular body 55 supported by the lower pipe portion 37 via the sealing member 52, and the bag 58 attached to the tubular body 55 into the outer container 2 through the first mouth portion 27.

The lower pipe portion 37 is an elongated member and its outer diameter is relatively small. Therefore, it is possible to reduce an outer diameter of the replaceable component 5 attached to the lower pipe portion 37. In addition, in an example shown in FIG. 23, due to the presence of the annular portion 40, the size of the first mouth portion 27 is set to be large. Therefore, since the outer diameter of the replaceable component 5 can be reduced and the size of the first mouth portion 27 is large, a whole of the replaceable component 5 can be smoothly inserted into the outer container 2 through the first mouth portion 27.

In a sixth step ST6, the attachment portion 31 of the lid member 3 is attached to the first mouth portion 27 of the outer container 2. The sixth step ST6 is a second attaching step. More specifically, in the second attaching step, the attachment portion 31 of the lid member 3 is threadably engaged with the first mouth portion 27 of the outer container 2.

In a seventh step ST7, the beverage container 1 is filled with a beverage. The seventh step ST7 is a beverage filling step. In the beverage filling step, the beverage is filled into the bag 58 which has been arranged inside the outer container 2.

In an example shown in FIG. 24, the beverage filling step includes filling the beverage (for example, an alcoholic beverage such as beer) into the bag 58 via the upper pipe portion 34 and the lower pipe portion 37 (see an arrow E1).

The beverage filling step may include discharging gas from a space SP3 between the outer container 2 and the bag 58 to the outside of the outer container 2 via the gas pipe portion 41 (see an arrow E2). Alternatively, the beverage filling step may include pushing an operating member 45 and discharging the gas from the space SP3 between the outer container 2 and the bag 58 to the outside of the outer container 2 through a hole in which the operating member 45 is arranged.

In the example shown in FIG. 24, the spacer member 63 is arranged between the annular portion 40 and the tubular body 55. The spacer member 63 prevents over-deformation (excessive deformation) of the bag 58 toward the annular portion 40 when the bag 58 is inflated by being filled with the beverage. In this way, damage to the bag 58 is prevented.

In the example shown in FIG. 24, the spacer member 63 prevents the bag 58 from coming into contact with the removal-preventing member 43 when the bag 58 is inflated. In this way, damage to the bag 58 is prevented.

In an eighth step ST8, a first closure member 70 is attached to the upper pipe portion 34. The eighth step ST8 is a third attaching step. In the third attaching step, the first closure member 70 capable of closing a second opening OP2 of the upper pipe portion 34 is attached to the upper pipe portion 34.

In the third attaching step, the first closure member 70 attached to the upper pipe portion 34 may have a closing part 72 movable from a closed position that prohibits the beverage from being taken out of the bag 58 to an open position that allows the beverage to be taken out of the bag 58 (see FIG. 17, FIG. 19, etc.). The closing part 72 moves from the closed position to the open position by being pushed or broken by a first connector 111 of a beverage dispenser 110. As shown in FIG. 17 and FIG. 19, the closing part 72 may be covered with a protective member 73.

Additionally, the method of assembling the beverage container according to some embodiments may include attaching a second closure member 75 covering the gas pipe portion 41 to the annular portion 40 of the lid member 3 or to the gas pipe portion 41.

### (Method of Taking Out a Beverage)

Next, a process of taking out a beverage from the beverage container 1 (in other words, a method of taking out a beverage from the beverage container 1) will be described. The process of taking out the beverage from the beverage container 1 constitutes a part of the method of handling the beverage container 1. In other words, the method of handling the beverage container 1 includes the process of taking out the beverage from the beverage container 1.

After executing the eighth step ST8, the beverage is taken out of the beverage container 1 in a ninth step ST9. The ninth step ST9 is a beverage extraction step. In the beverage extraction step, the beverage is taken out of the bag 58 which has been arranged inside the outer container 2. Each of FIGS. 2, 18 and 20 shows a state during execution of the beverage extraction step. The extraction of the beverage from the bag 58 is executed by using the beverage dispenser 110 and a gas supply device 120.

In the beverage extraction step, firstly, in a sub-step ST9-1, the first connector 111 of the beverage dispenser 110 is fluidly connected to the upper pipe portion 34 of the lid member 3, and a second connector 121 of the gas supply device 120 is fluidly connected to the gas pipe portion 41 of the lid member 3. The sub-step ST9-1 is a connecting step. The first connector 111 may be directly or indirectly attached to the upper pipe portion 34 of the lid member 3 by way of thread connection. Alternatively, the first connector 111 may be directly or indirectly attached to the upper pipe portion 34 of the lid member 3 in a one-touch manner. Also, the second connector 121 may be attached to the gas pipe portion 41 by thread [symbol] connection or a one-touch manner.

In the example shown in FIG. 2, the sub-step ST9-1 includes attaching the first connector 111 of the beverage dispenser 110 directly to the upper pipe portion 34 of the lid member 3.

Alternatively, the sub-step ST9-1 may include indirectly attaching the first connector 111 of the beverage dispenser 110 to the upper pipe portion 34 of the lid member 3. More specifically, as shown in FIGS. 18 and 20, the first connector 111 of the beverage dispenser 110 may be attached to the first closure member 70 arranged on the upper pipe portion 34 of the lid member 3. In the example shown in FIGS. 18 and 20, a tip portion 111t of the first connector 111 pushes or breaks the closing part 72 when the first connector 111 is attached to the first closure member 70. In this way, the closing part 72 moves from the closed position to the open position. In this case, outside air is prevented or suppressed from entering the bag 58 when the closing part 72 moves from the closed position to the open position.

In the beverage extraction step, secondly, in a sub-step ST9-2, gas (for example, air) is supplied from the gas supply device 120 to the space SP3 between the outer container 2 and the bag 58 through the gas pipe portion 41. The sub-step ST9-2 is a gas supplying step.

The gas supplied to the space SP3 through the gas pipe portion 41 in the gas supplying step presses the bag 58 so that the bag 58 contracts.

In the beverage extraction step, thirdly, in a sub-step ST9-3, the beverage is taken out of the bag 58. The beverage is taken out via the lower pipe portion 37 of the lid member 3 and the upper pipe portion 34 of the lid member 3.

In the method of taking out the beverage according to some embodiments, the beverage is taken out of the bag 58 by supplying the gas to the space SP3 between the outer container 2 and the bag 58. Therefore, the beverage in the bag 58 does not come in contact with the supply gas (for example, air) supplied via the gas pipe portion 41. Therefore, the taste, texture, and the like of the beverage do not deteriorate due to the contact of the beverage with the supplied gas. Moreover, when the beverage is a sparkling beverage such as beer, the feel of the foam does not deteriorate.

Further, in the method of taking out the beverage according to some embodiments, it is possible to use air as the gas to be supplied to the space SP3 between the outer container 2 and the bag 58. Therefore, it is not necessary to prepare a carbon dioxide gas cylinder unlike the conventional method of taking out the beverage. It should be noted that using air as the gas to be supplied to the space SP3 is an optional configuration. In other words, in some embodiments, as the gas to be supplied to the space SP3 between the outer container 2 and the bag 58, the use of gas other than air (for example, carbon dioxide gas) is not excluded.

When the outer container 2 is made of stainless steel, durability and corrosion resistance of the outer container 2 are extremely high, and light-shielding property is excellent. Therefore, the outer container 2 with the bag 58 arranged therein may be stored outdoors.

### (Method of Disassembling Beverage Container 1)

Next, a process of disassembling the beverage container 1 (in other words, a method of disassembling the beverage container 1) will be described. The process of disassembling the beverage container 1 constitutes a part of the method of handling the beverage container 1. In other words, the method of handling the beverage container 1 includes the process of disassembling the beverage container 1.

After executing the ninth step ST9, the beverage container 1 is disassembled in a tenth step ST10. The tenth step ST10 is a disassembling step.

The disassembling step (the tenth step ST10) includes removing the lid member 3 from the outer container 2 and removing the replaceable component 5 from the lower pipe portion 37 of the lid member 3.

When the beverage container 1 is provided with the removal-preventing member 43, removal of the lid member 3 from the outer container 2 is performed in a state in which an engaging member 44 of the removal-preventing member 43 is retracted from an engaging portion 28 of the outer container 2 (see FIG. 14). Alternatively, removal of the lid member 3 from the outer container 2 may be performed after the removal-preventing member 43 is destroyed.

Removing the replaceable component 5 from the lower pipe portion 37 of the lid member 3 includes sliding the sealing member 52 and the tubular body 55 of the replaceable component 5 along the lower pipe portion 37 in a direction toward the lower end of the lower pipe portion 37. In the disassembling step, the replaceable component 5 can be removed from the lower pipe portion 37 simply by sliding the sealing member 52 and the tubular body 55 along the lower pipe portion 37. Therefore, it is possible to quickly and easily remove the replaceable component 5 from the lower pipe portion 37.

The lid member 3 from which the replaceable component 5 has been removed and the outer container 2 are preferably reused in the next beverage filling. On the other hand, once used replaceable component 5 is preferably replaced with another replaceable component (more specifically, a new replaceable component). Note that, since the structure of the replaceable component 5 according to some embodiments is simple, manufacturing cost of the replaceable component 5 is low.

In some embodiments, the bag 58 is filled with the beverage and the beverage does not come in direct contact with the reusable outer container 2. Therefore, safety of the beverage is reliably ensured. In addition, since the beverage does not come in direct contact with the reusable outer container 2, adhesion of organic substances (dirt) or odors to the interior of the outer container 2 is suppressed. From the foregoing, it becomes easy to manage the outer container when the outer container 2 is collected and reused. Moreover, it is possible to simplify a process of cleaning the outer container 2.

The present invention is not limited to each of the above embodiments or each of the above-mentioned modified examples, and it is clear that each embodiment or each modified example can be appropriately modified or can be changed within the scope of the technical idea of the present invention. In addition, the various techniques used in each embodiment or each modified example can be applied to other embodiments or other modified examples as long as there is no technical contradiction. Further, any optional configuration in each embodiment or each modified example can be omitted as appropriate.

### DESCRIPTION OF THE REFERENCE NUMERALS

1 beverage container, 2 outer container, 3 lid member, 5 replaceable component, 22 container main body, 23 bottom portion, 24 body portion, 25 shoulder portion, 26 welded portion, 27 first mouth portion, 27e upper surface of first mouth portion, 27g lower end of first mouth portion, 27n inner surface of first mouth portion, 27s first threaded portion, 28 engaging portion, 31 attachment portion, 31s second threaded portion, 34 upper pipe portion, 35 first connecting portion, 35s third threaded portion, 37 lower pipe portion, 37a large diameter portion, 37b stopper surface, 37c small diameter portion, 37u outer surface of lower pipe portion, 39 biasing member, 40 annular portion, 40d recess portion of annular portion, 40e top surface of annular portion, 40g lower surface of annular portion, 40h gas inlet port, 40n inner edge portion of annular portion, 40u outer edge portion of annular portion, 40w welded portion, 41 gas pipe portion, 41a first pipe portion, 41b second pipe portion, 41c second connecting portion, 42 gas valve, 43, 43A, 43B removal-preventing member, 44 engaging member, 44c inclined surface, 45 operating member, 45c pressing surface, 46 biasing member, 47 annular member, 48 engaging portion, 52 sealing member, 55 tubular body, 55b top surface of tubular body, 55e upper end portion of tubular body, 55g lower end portion of tubular body, 58 bag, 58c mouth portion of bag, 63 spacer member, 63d lower surface of spacer member, 63e upper end portion of spacer member, 63g lower end of spacer member, 63h through hole portion, 63n inner edge portion of spacer member, 65 sealing ring, 70 first closure member, 71 cap, 71a top plate, 71b annular wall, 71c female threaded portion, 72, 72A closing part, 72B first valve body, 73 protective member, 74 biasing member, 75 second closure member, 110 beverage dispenser, 111 first connector, 111t tip portion of first connector, 120 gas supply device, 121 second connector, 121t tip portion of second connector, 130 removal tool, 131 holding portion, 132 pushing portion, 401 inner portion of annular portion, 402 outer portion of annular portion, 421 second valve body, 423 second valve seat portion, 522 lower lip portion, 522n inner surface of lower lip portion, 522u first outer peripheral surface of lower lip portion, 524 annular protruding portion, 526 upper lip portion, 526n inner surface of upper lip portion, 526u second outer peripheral surface of upper lip portion, 551 tubular portion, 553 first flange, 555 second flange, 557 annular groove, 633 outer shell portion, 635 reinforcing rib, 637 receiving space, 710 first valve seat portion, D beverage, F1 beverage flow channel, G1 gap, G2 gap, OP1 first opening, OP2 second opening

1. A beverage container comprising:
an outer container having a first mouth portion;
a lid member attached to the outer container; and
a replaceable component attached to the lid member,
wherein the lid member includes:
an attachment portion attached to the first mouth portion;
an upper pipe portion arranged outside the outer container;
an annular portion extending outward from the upper pipe portion and connecting the upper pipe portion and the attachment portion; and
a lower pipe portion extending downward from the annular portion,
wherein the replaceable component includes:
a sealing member slidable with respect to the lower pipe portion and being in annular contact with an outer surface of the lower pipe portion at an installation position;
a tubular body holding the sealing member and being supported by the lower pipe portion via the sealing member located at the installation position; and
a bag for containing a beverage attached to the tubular body.

2. The beverage container according to claim 1,
wherein the attachment portion extends downward from an outer edge portion of the annular portion,
wherein the upper pipe portion extends upward from an inner edge portion of the annular portion, and
wherein the lower pipe portion extends downward from the inner edge portion of the annular portion.

3. The beverage container according to claim 1, further comprising:
a spacer member arranged between the annular portion and the tubular body and preventing the bag from being over-deformed toward the annular portion,
wherein the tubular body is movable relative to the spacer member.

4. The beverage container according to claim 3,
wherein the spacer member has a lower surface arranged to face the bag, and
wherein the lower surface of the spacer member is an inclined surface whose height decreases as a distance from the lower pipe portion increases.

5. The beverage container according to claim 1,
wherein the upper pipe portion includes a first connecting portion connectable directly or indirectly to a beverage dispenser,
wherein the lid portion includes:
a gas pipe portion arranged in the annular portion; and
a second connecting portion arranged in the gas pipe portion and being connectable to a gas supply device.

6. The beverage container according to claim 5,
wherein the annular portion includes a recess portion recessed downward with respect to a top surface of the annular portion, and
wherein at least a part of the gas pipe portion is arranged in the recess portion.

7. The beverage container according to claim 1,
wherein the lid member includes a removal-preventing member preventing the lid member from being removed from the outer container,
wherein the removal-preventing member includes:
an engaging member engageable with the outer container; and
an operating member disposed in the annular portion and operating the engaging member.

8. The beverage container according to claim 1, further comprising:
a first closure member attached to the upper pipe portion,
wherein the first closure member includes a closing part movable from a closed position prohibiting the beverage from being taken out of the bag to an open position allowing beverage extraction from the bag, and
wherein the closing part moves from the closed position to the open position by being pushed or broken by a connector.

9. The beverage container according to claim 1,
wherein the sealing member has a lower lip portion,
wherein the lower lip portion has a first outer peripheral surface to which a first internal pressure inside the bag is applied, and
wherein the first outer peripheral surface is exposed to a space inside the bag.

10. The beverage container according to claim 1,
wherein the sealing member has an upper lip portion,
wherein the upper lip portion has a second outer peripheral surface, and
wherein the second outer peripheral surface is arranged outside the bag.

11. The beverage container according to claim 1,
wherein the tubular body includes:
a tubular portion holding the sealing member;
a first flange to which the bag is attached; and
a second flange located above the first flange, and
wherein an outer diameter of the second flange is smaller than an outer diameter of the first flange.

12. A method of assembling a beverage container comprising:
preparing an outer container having a first mouth portion;
preparing a lid member that comprises an attachment portion attachable to the first mouth portion, an upper pipe portion arranged outside the outer container, an annular portion extending outward from the upper pipe portion and connecting the upper pipe portion and the attachment portion, and a lower pipe portion extending downward from the annular portion;
preparing a replaceable component that comprises a sealing member, a tubular body holding the sealing member, and a bag for containing a beverage attached to the tubular body;
attaching the replaceable component to the lower pipe portion;
inserting the replaceable component and the lower pipe portion into the outer container; and
attaching the attachment portion of the lid member to the first mouth portion of the outer container,
wherein the attaching the replaceable component to the lower pipe portion includes:
sliding the sealing member and the tubular body with respect to the lower pipe portion; and
making the sealing member into annular contact with an outer surface of the lower pipe portion at an installation position, and
wherein the inserting the replaceable component and the lower pipe portion into the outer container includes:
inserting the lower pipe portion, the sealing member attached to the lower pipe portion, the tubular body supported by the lower pipe portion via the sealing member, and the bag attached to the tubular body into the outer container through the first mouth portion.
